(19) United States
(12) Patent Application Publication
(10) Pub. No.: US 2018/0005728 A1
(43) Pub. Date: Jan. 4, 2018

(54) CABLE JACKET HAVING DESIGNED MICROSTRUCTURES AND METHODS FOR MAKING CABLE JACKETS HAVING DESIGNED MICROSTRUCTURES

(71) Applicant: Dow Global Technologies LLC, Midland, MI (US)

(72) Inventors: Mohamed Esseghir, Collegeville, PA (US); Wenyi Huang, Midland, MI (US); Joseph Dooley, Charlestown, IN (US); Chang Dong Lee, Burlington, VT (US); Saswati Pujari, Collegeville, PA (US); Chester J. Kmiec, Phillipsburg, NJ (US)

(21) Appl. No.: 15/544,413

(22) PCT Filed: Aug. 25, 2016
(86) PCT No.: PCT/US2016/016047

§ 371 Date: Jul. 18, 2017

Related U.S. Application Data
(60) Provisional application No. 62/118,613, filed on Feb. 20, 2015.

(51) Int. Cl. H01B 7/02; H01B 3/28; H01B 3/30; H01B 3/46

(52) U.S. Cl. CPC H01B 7/02; H01B 3/46; H01B 3/28; H01B 3/308

(57) ABSTRACT

Coated conductors comprising a conductor and elongated polymeric coatings at least partially surrounding the conductor, where the elongated polymeric coatings comprise a polymeric matrix material and a plurality of microcapillaries containing an elastomeric polymeric material. Also disclosed are dies and methods for making such coated conductors.

### REFERENCE TO RELATED APPLICATIONS

The present application claims the benefit of U.S. Provisional Application No. 62/118,613, filed on Feb. 20, 2015.

### FIELD

Various embodiments of the present invention relate to cable coatings and jackets having microcapillary structures.

### INTRODUCTION

In a typical cable construction, whether it is a power or telecommunication cable, a cable's jacket is the primary external protection. In most cases, a cable's jacket is the outer-most layer, which is exposed to external elements such moisture, heat, UV light, or mechanical abuse. Therefore, jacket materials are often selected for good mechanical strength, toughness, and abrasion resistance. Additionally, for ease of installation, other properties can be important for a cable jacket, such as surface smoothness, low coefficient of friction, and flexibility. These requirements are rarely met in a cost-effective manner in a single material. For this reason, cable manufacturers are often required to compromise properties and select materials depending on the most critical requirement for a given application. For example, manufacturers can select from materials such as high-density polyethylene (“HDPE”), medium-density polyethylene (“MDPE”), low-density polyethylene (“LDPE”), linear-low-density polyethylene (“LLDPE”), ethylene-vinyl acetate (“EVA”), ethylene ethyl acrylate (“EEA”), polyvinyl chloride (“PVC”), thermoplastic polyurethane (“TPU”), and polyamides (e.g., nylon), among others. When choosing one of these materials, property compromise can be significant. For example, in cases where high toughness and abrasion resistance are needed, a cost-effective material such as HDPE might be selected; however, there would be a negative impact on flexibility and thus ease of installation. This negative impact becomes even more severe in low-temperature climates or during winter installations. On the other hand, if flexibility is the most desired property, then one might select a polyolefin copolymer, such EVA, or a polyolefin elastomer; this, however, will lead to a compromise in mechanical properties such as abrasion and tear resistance. In addition, flexible materials tend to be softer and exhibit rubbery characteristics, along with a higher coefficient of friction (“COF”), and thus lead to higher resistance when cables are installed inside ducts. Furthermore, most cost-effective thermoplastic elastomers tend to have higher oil absorption compared to higher crystallinity polyolefins, which can have a negative long-term impact on properties.

One approach to balance performance has been to use blend compounds consisting of one or more higher modulus, higher density, and tougher materials with one or more elastomeric components to improve flexibility. In such cases, a randomly located rubbery phase in the blend compound generally negatively affects some key properties, such as COF and oil pickup for example, requiring costly formulation approaches. Accordingly, improvements in cable jacket compositions and structures are desired.

### SUMMARY

One embodiment is a coated conductor, comprising:
(a) a conductor; and
(b) an elongated polymeric coating surrounding at least a portion of said conductor,
wherein said elongated polymeric coating comprises a polymeric matrix material and a plurality of microcapillaries which extend substantially in the direction of elongation of said elongated polymeric coating,
wherein at least a portion of said microcapillaries contain a polymeric microcapillary material,
wherein said polymeric microcapillary material is an elastomer.

### BRIEF DESCRIPTION OF THE DRAWINGS

Reference is made to the accompanying drawings in which:

FIG. 1 is a perspective view, partially in cross-section, of an extruder with a die assembly for manufacturing a microcapillary film;

FIG. 2A is a longitudinal-sectional view of a microcapillary film;

FIGS. 2B and 2C are cross-sectional views of a microcapillary film;

FIG. 2D is an elevated view of a microcapillary film;

FIG. 2E is a segment 2E of a longitudinal sectional view of the microcapillary film, as shown in FIG. 2B;

FIG. 2F is an exploded view of a microcapillary film;

FIG. 2G is a cross-sectional view of a microcapillary film particularly depicting a single-layer embodiment;

FIGS. 3A and 3B are schematic perspective views of various configurations of extruder assemblies including an annular die assembly for manufacturing coextruded multi-layer annular microcapillary products and air-filled multi-layer annular microcapillary products, respectively;

FIG. 4A is a schematic view of a microcapillary film having microcapillaries with a fluid therein;

FIG. 4B is a cross-sectional view of a coextruded microcapillary film;

FIG. 4C is a cross-sectional view of an inventive air-filled microcapillary film;

FIG. 5 is a schematic view of an annular microcapillary tubing extruded from a die assembly;

FIGS. 6A and 6B are perspective views of an annular microcapillary tubing;

FIGS. 7A-7D are partial cross-sectional, longitudinal cross-sectional, end, and detailed cross-sectional views, respectively, of an annular die assembly in an asymmetric flow configuration;

FIGS. 8A-8D are partial cross-sectional, longitudinal cross-sectional, end, and detailed cross-sectional views, respectively, of an annular die assembly in a symmetric flow configuration;

FIGS. 9A-9D are partial cross-sectional, longitudinal cross-sectional, end, and detailed cross-sectional views, respectively, of an annular die assembly in a symmetric flow configuration; and

FIG. 10 is a perspective view of a die insert for an annular die assembly.

### DETAILED DESCRIPTION

The present disclosure relates to die assemblies and extruders for producing annular microcapillary products. Such annular microcapillary products may be used in fabricating wire and cable articles of manufacture, such as by forming at least a portion of a polymeric coating (e.g., a jacket) or a polymeric protective component surrounding a conductive core.

The die assembly includes an annular die insert positioned between manifolds and defining material flow channels therebetween for extruding layers of a thermoplastic material. The die insert has a tip having microcapillary flow channels on an outer surface for insertion of microcapillary material in microcapillaries between the extruded layers of thermoplastic material. The microcapillaries may contain a variety of materials, such as other thermoplastic materials or elastomeric materials, or may simply be void-space microcapillaries (i.e., containing a gas, such as air). The die assemblies for producing annular microcapillary products are a variation of die assemblies for producing multi-layer microcapillary films, both of which are described in greater detail, below.

### Microcapillary Film Extruder

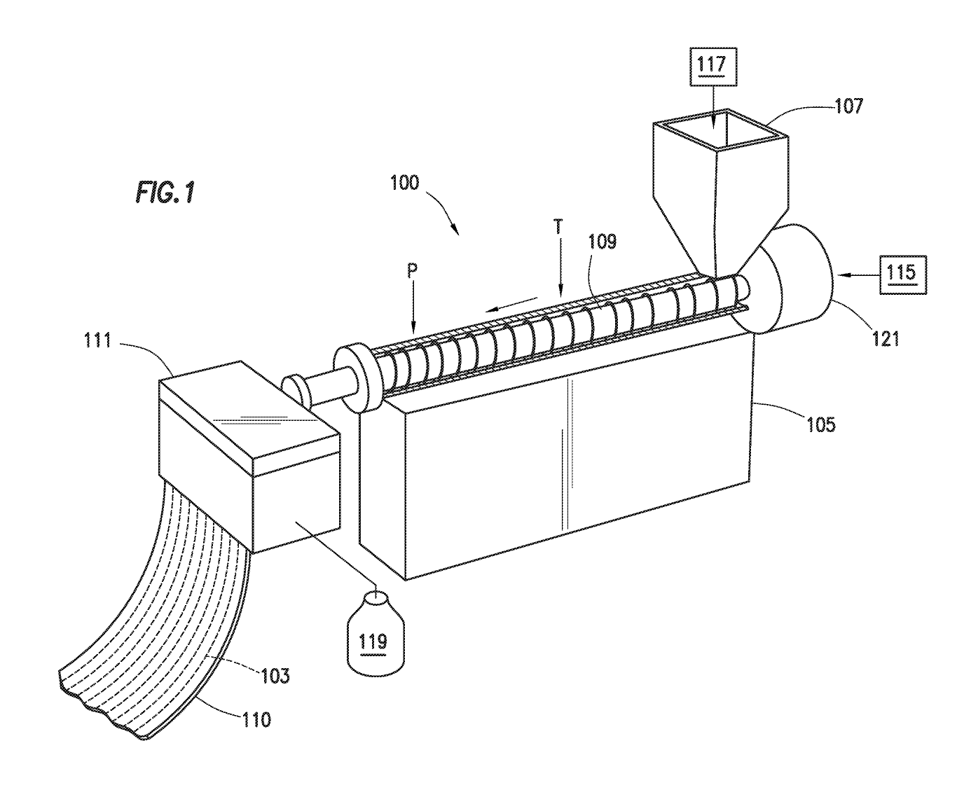

FIG. 1 depicts an example extruder (100) used to form a multi-layer polymeric film (110) with microcapillaries (103). The extruder (100) includes a material housing (105), a material hopper (107), a screw (109), a die assembly (111) and electronics (115). The extruder (100) is shown partially in cross-section to reveal the screw (109) within the material housing (105). While a screw type extruder is depicted, a variety of extruders (e.g., single screw, twin screw, etc.) may be used to perform the extrusion of the material through the extruder (100) and die assembly (111). One or more extruders may be used with one or more die assemblies. Electronics (115) may include, for example, controllers, processors, motors and other equipment used to operate the extruder.

Raw materials (e.g. thermoplastic materials) (117) are placed into the material hopper (107) and passed into the housing (105) for blending. The raw materials (117) are heated and blended by rotation of the screw (109) rotationally positioned in the housing (105) of the extruder (100). A motor (121) may be provided to drive the screw (109) or other driver to advance the raw materials (117). Heat and pressure are applied as schematically depicted from a heat source T and a pressure source P (e.g., the screw (109)), respectively, to the blended material to force the raw material (117) through the die assembly (111) as indicated by the arrow. The raw materials (117) are melted and conveyed through the extruder (100) and die assembly (111). The molten raw material (117) passes through die assembly (111) and is formed into the desired shape and cross section (referred to herein as the ‘profile’). The die assembly (111) may be configured to extrude the molten raw material (117) into thin sheets of the multi-layer polymeric film (110) as is described further herein.

### Microcapillary Film

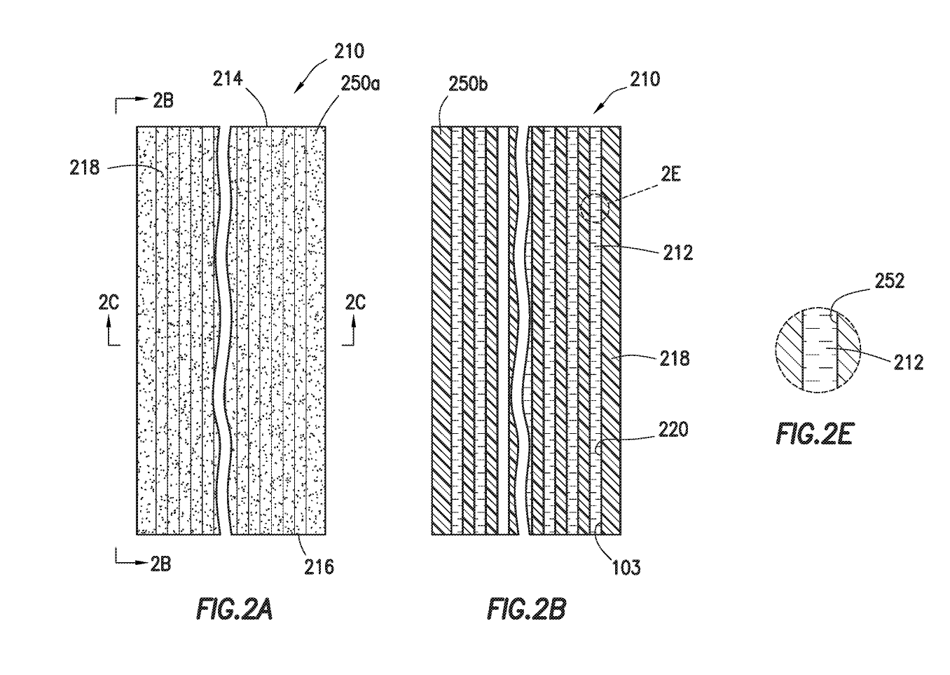

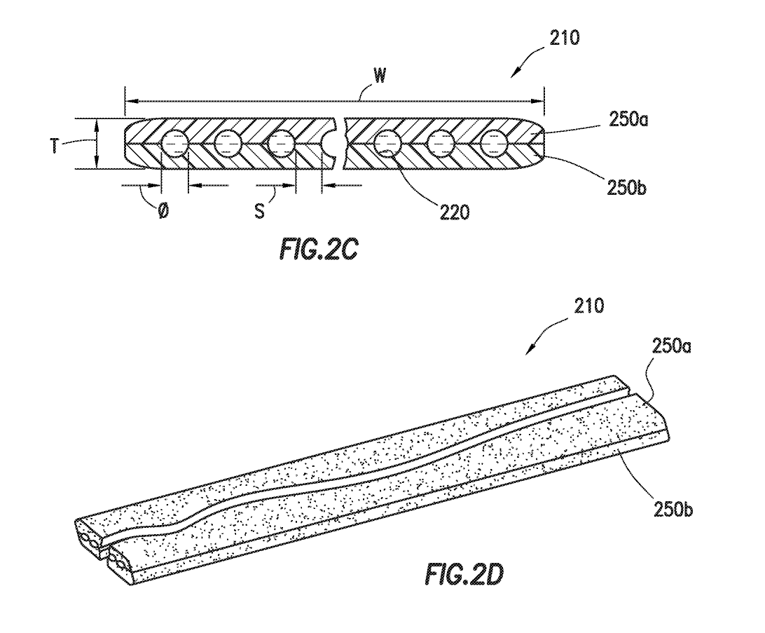

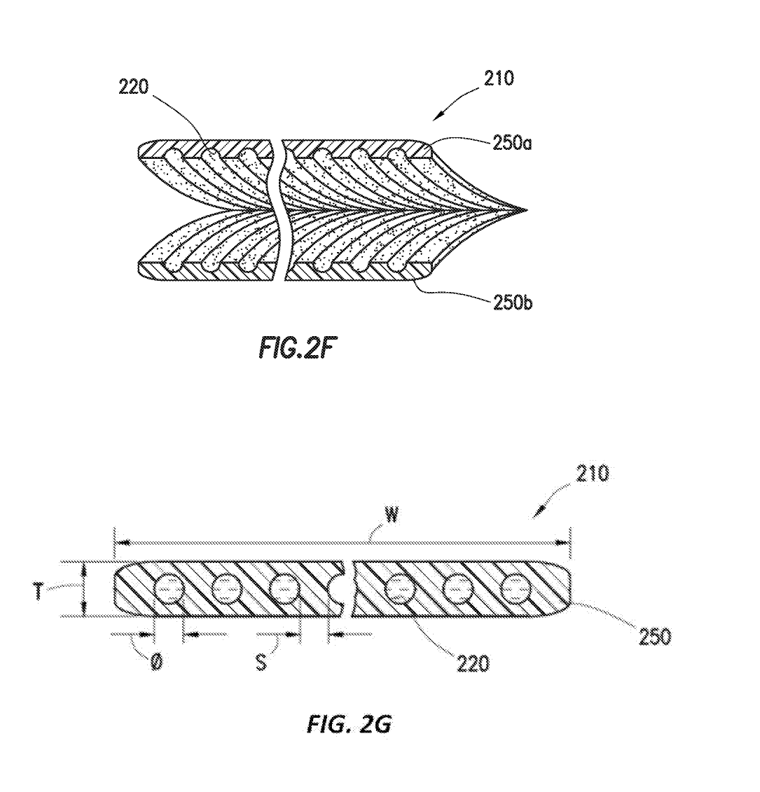

FIGS. 2A-2F depict various views of a multi-layer film (210) which may be produced, for example, by the extruder (100) and die assembly (111) of FIG. 1. As shown in FIGS. 2A-2F, the multi-layer film (210) is a microcapillary film. The multi-layer film (210) is depicted as being made up of multiple layers (250a,b) of thermoplastic material. The film (210) also has channels (220) positioned between the layers (250a,b).

The multi-layer film (210) may also have an elongate profile as shown in FIG. 2C. This profile is depicted as having a wider width W relative to its thickness T. The width W may be in the range of from 3 inches (7.62 cm) to 60 inches (152.40 cm) and may be, for example, 24 inches (60.96 cm) in width, or in the range of from 20 to 40 inches (50.80-101.60 cm), or in the range of from 20 to 50 inches (50.80-127 cm), etc. The thickness T may be in the range of from 100 to 2,000 μm (e.g., from 250 to 2000 μm). The channels (220) may have a dimension φ (e.g., a width or diameter) in the range of from 50 to 500 μm (e.g., from 100 to 500 μm, or 250 to 500 μm), and have a spacing S between the channels (220) in the range of from 50 to 500 μm (e.g., from 100 to 500 μm, or 250 to 500 μm). As further described below, the selected dimensions may be proportionally defined. For example, the channel dimension φ may be a diameter of about 30% of thickness T.

As shown, layers (250a,b) are made of a matrix thermoplastic material and channels (220) have a channel fluid (212) therein. The channel fluid may comprise, for example, various materials, such as air, gas, polymers, etc., as will be described further herein. Each layer (250a,b) of the multi-layer film (210) may be made of various polymers, such as those described further herein. Each layer may be made of the same material or of a different material. While only two layers (250a,b) are depicted, the multi-layer film (210) may have any number of layers of material.

It should be noted that when the same thermoplastic material is employed for the layers (250a,b), then a single layer (250) can result in the final product, due to fusion of the two streams of the matrix layers comprised of the same polymer in a molten state merging shortly before exiting the die. This phenomenon is depicted in FIG. 2G.

Channels (220) may be positioned between one or more sets of layers (250a,b) to define microcapillaries (252) therein. The channel fluid (212) may be provided in the channels (220). Various numbers of channels (220) may be provided as desired. The multiple layers may also have the same or different profiles (or cross-sections). The characteristics, such as shape of the layers (250a,b) and/or channels (220) of the multi-layer film (210), may be defined by the configuration of the die assembly used to extrude the thermoplastic material as will be described more fully herein.

The microcapillary film (210) may have a thickness in the range of from 100 μm to 3,000 μm; for example, microcapillary film or foam (210) may have a thickness in the range of from 100 to 2,000 μm, from 100 to 1,000 μm, from 200 to 800 μm, from 200 to 600 μm, from 300 to 1,000 μm, from 300 to 900 μm, or from 300 to 700 μm. The film-thickness-to-microcapillary-diameter ratio can be in the range of from 2:1 to 400:1.

The microcapillary film (210) may comprise at least 10 percent by volume (“vol %”) of the matrix (218), based on the total volume of the microcapillary film (210); for example, the microcapillary film (210) may comprise from 10 to 80 vol % of the matrix (218), from 20 to 80 vol % of the matrix (218), or from 30 to 80 vol % of the matrix (218), based on the total volume of the microcapillary film (210).

The microcapillary film (210) may comprise from 20 to 90 vol % of voidage, based on the total volume of the microcapillary film (210); for example, the microcapillary film (210) may comprise from 20 to 80 vol % of voidage, from 20 to 70 vol % of voidage, or from 30 to 60 vol % of voidage, based on the total volume of the microcapillary film (210).

The microcapillary film (210) may comprise from 50 to 100 vol % of the channel fluid (212), based on the total voidage volume, described above; for example, the microcapillary film (210) may comprise from 60 to 100 vol % of the channel fluid (212), from 70 to 100 vol % of the channel fluid (212), or from 80 to 100 vol % of the channel fluid (212), based on the total voidage volume, described above.

The microcapillary film (210) has a first end (214) and a second end (216). One or more channels (220) are disposed in parallel in the matrix (218) from the first end (214) to the second end (216). The one or more channels (220) may be, for example, at least about 250 μm apart from each other. The one or more channels (220) can have a diameter of at least 250 μm, or in the range of from 250 to 1990 μm, from 250 to 990 μm, from 250 to 890 μm, from 250 to 790 μm, from 250 to 690 μm, or from 250 to 590 μm. The one or more channels (220) may have a cross sectional shape selected from the group consisting of circular, rectangular, oval, star, diamond, triangular, square, the like, and combinations thereof. The one or more channels (220) may further include one or more seals at the first end (214), the second end (216), therebetween the first end (214) and the second end (216), or combinations thereof.

The matrix (218) comprises one or more matrix thermoplastic materials. Such matrix thermoplastic materials include, but are not limited to, polyolefins (e.g., polyethylenes, polypropylenes, etc.); polyamides (e.g., nylon 6); polyvinylidene chloride; polyvinylidene fluoride; polycarbonate; polystyrene; polyethylene terephthalate; polyurethane; and polyester. Specific examples of matrix thermoplastic materials include those listed on pages 5 through 11 of PCT Published Application No. WO 2012/094315, titled “Microcapillary Films and Foams Containing Functional Filler Materials,” which are herein incorporated by reference.

The matrix (218) may be reinforced via, for example, glass or carbon fibers and/or any other mineral fillers such talc or calcium carbonate. Exemplary fillers include, but are not limited to, natural calcium carbonates (e.g., chalks, calcites and marbles), synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, wood fiber or powder or mixtures of these compounds.

The one or more channel fluids (212) may include a variety of fluids, such as air, other gases, or channel thermoplastic material. Channel thermoplastic materials include, but are not limited to, polyolefins (e.g., polyethylenes, polypropylenes, etc.); polyamides (e.g., nylon 6); polyvinylidene chloride; polyvinylidene fluoride; polycarbonate; polystyrene; polyethylene terephthalate; polyurethane; and polyester. As with the matrix (218) materials discussed above, specific examples of thermoplastic materials suitable for use as channel fluids (212) include those listed on pages 5 through 11 of PCT Published Application No. WO 2012/094315.

When a thermoplastic material is used as the channel fluid (212), it may be reinforced via, for example, glass or carbon fibers and/or any other mineral fillers such talc or calcium carbonate. Exemplary reinforcing fillers include those listed above as suitable for use as fillers in the matrix (218) thermoplastic material.

### Annular Microcapillary Product Extruder Assemblies

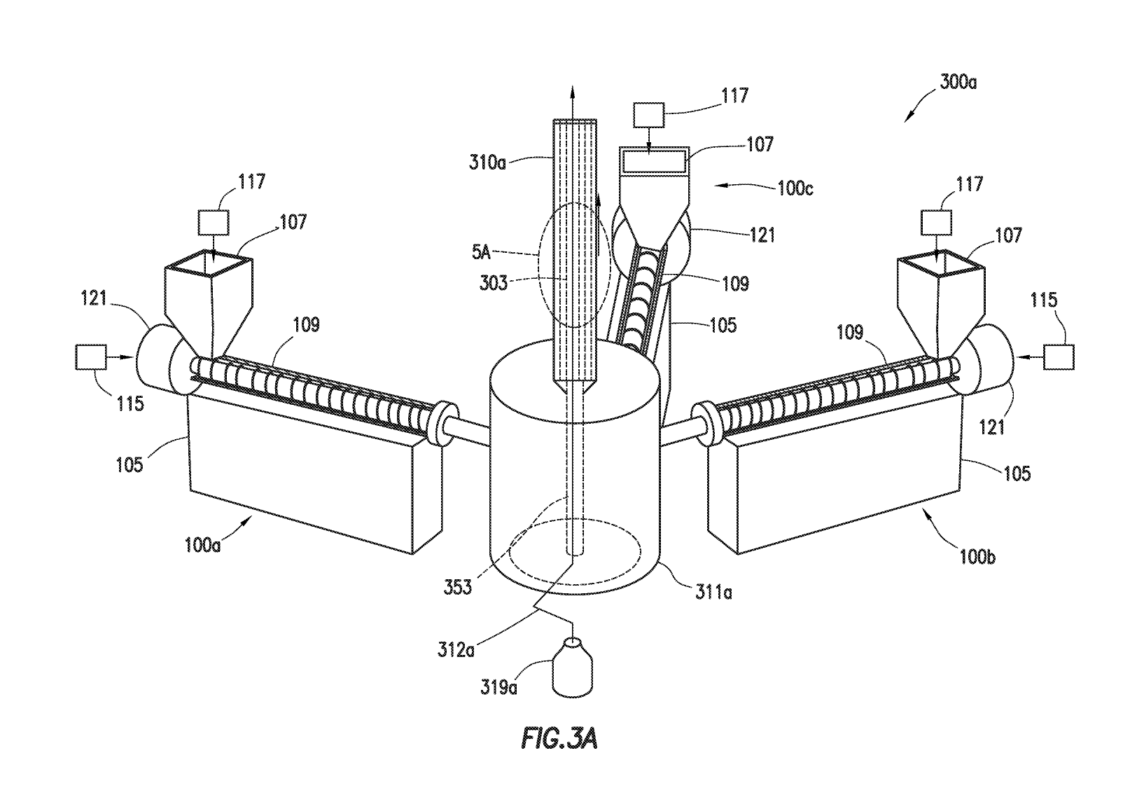

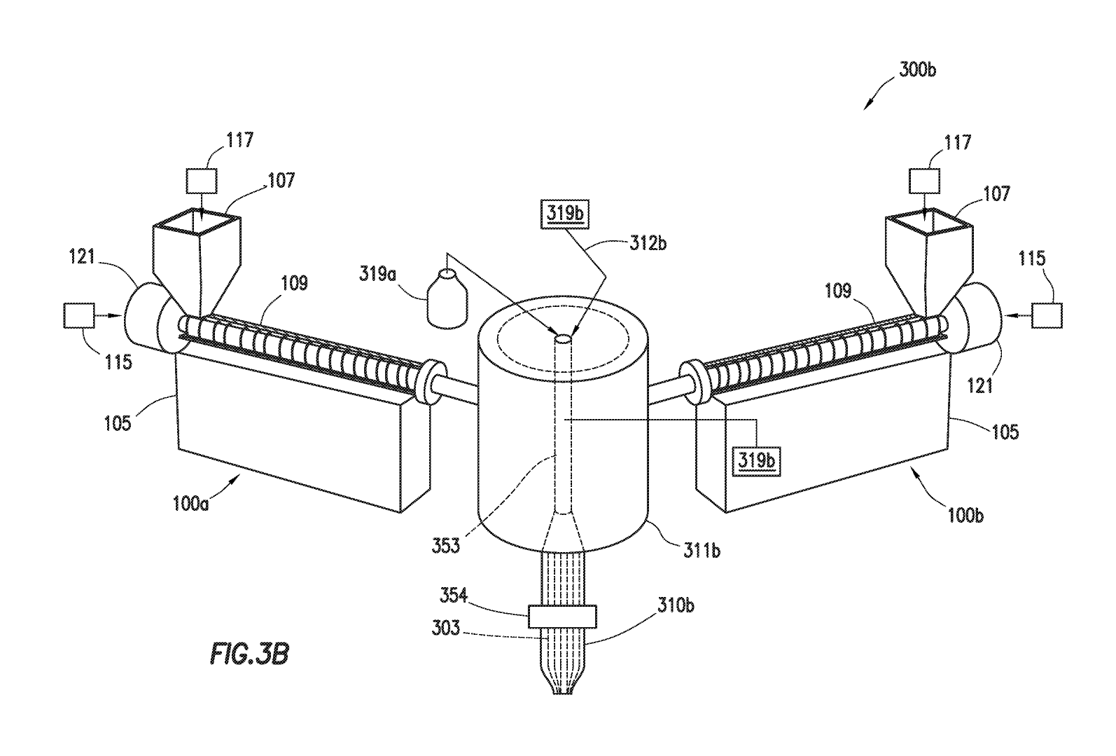

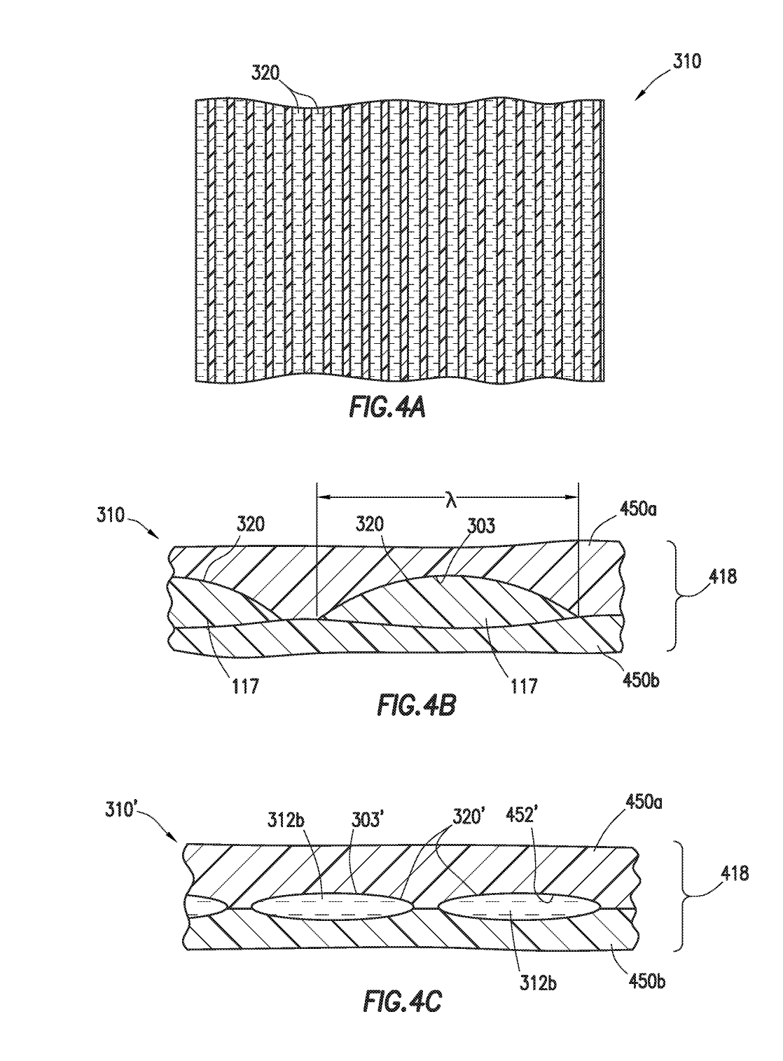

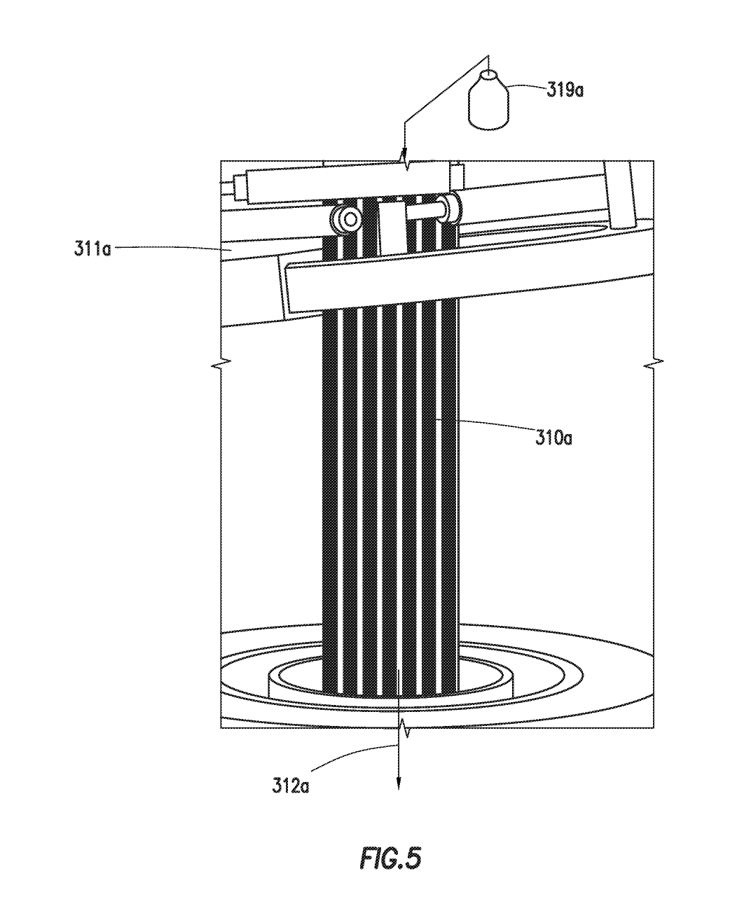

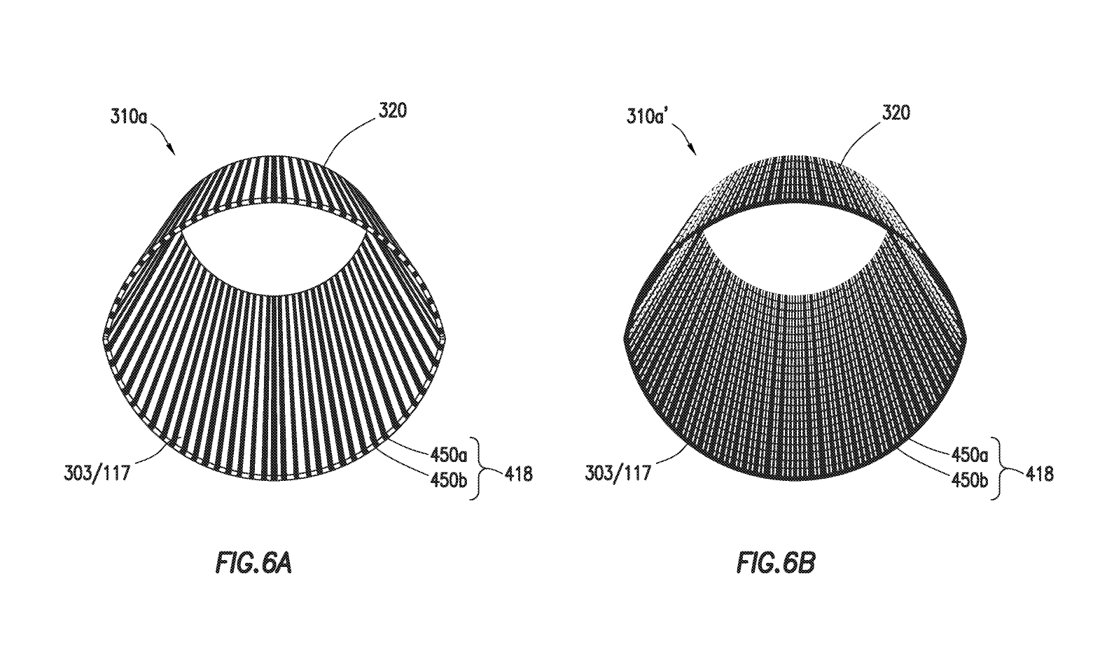

FIGS. 3A and 3B depict example extruder assemblies (300a,b) used to form a multi-layer, annular microcapillary product (310a,b) having microcapillaries (303). The extruder assemblies (300a,b) may be similar to the extruder (100) of FIG. 1 as previously described, except that the extruder assemblies (300a,b) include multiple extruders (100a,b,c), with combined annular microcapillary co-extrusion die assemblies (311a,b) operatively connected thereto. The annular die assemblies (311a,b) have die inserts (353) configured to extrude multi-layer, annular microcapillary products, such as film (310) as shown in FIGS. 4A-4C, tubing (310a) as shown in FIGS. 5, 6A, and 6B, and/or molded shapes (310b) as shown in FIG. 3B.

FIG. 3A depicts a first configuration of an extruder assembly (300a) with three extruders (100a,b,c) operatively connected to the combined annular microcapillary co-extrusion die assembly (311a). In an example, two of the three extruders may be matrix extruders (100a,b) used to supply thermoplastic material (e.g., polymer) (117) to the die assembly (311a) to form layers of the annular microcapillary product (310a). A third of the extruders may be a microcapillary (or core layer) extruder (100c) to provide a microcapillary material, such as a thermoplastic material (e.g., polymer melt) (117), into the microcapillaries (303) to form a microcapillary phase (or core layer) therein.

The die insert (353) is provided in the die assembly (311a) to combine the thermoplastic material (117) from the extruders (100a,b,c) into the annular microcapillary product (310a). As shown in FIG. 3A, the multi-layer, annular microcapillary product may be a blown tubing (310a) extruded upwardly through the die insert (353) and out the die assembly (311a). Annular fluid (312a) from a fluid source (319a) may be passed through the annular microcapillary product (310a) to shape the multi-layer, annular microcapillary tubing (310a) during extrusion as shown in FIG. 3A, or be provided with a molder (354) configured to produce a multi-layer, annular microcapillary product in the form of an annular microcapillary molding (or molded product), such as a bottle (310b) as shown in FIG. 3B.

FIG. 3B shows a second configuration of an extruder assembly (300b). The extruder assembly (300b) is similar to the extruder assembly (300a), except that the microcapillary extruder (100c) has been replaced with a microcapillary fluid source (319b). The extruders (100a,b) extrude thermoplastic material (as in the example of FIG. 3A) and the microcapillary fluid source (319b) may emit micocapillary material in the form of a microcapillary fluid (312b) through the die insert (353) of the die assembly (311b). The two matrix extruders (100a,b) emit thermoplastic layers, with the microcapillary fluid source (319b) emitting microcapillary fluid (312b) into the microcapillaries (303) therebetween to form the multi-layer, annular microcapillary product (310b). In this version, the annular die assembly (311b) may form film or blown products as in FIG. 3A, or be provided with a molder (354) configured to produce a multi-layer, annular microcapillary product in the form of an annular microcapillary molding (or molded product), such as a bottle, (310b).

While FIGS. 3A and 3B show each extruder (100a,b,c) as having a separate material housing (105), material hopper (107), screw (109), electronics (115), motor (121), part or all of the extruders (100) may be combined. For example, the extruders (100a,b,c) may each have their own hopper (107), and share certain components, such as electronics (115) and die assembly (311a,b). In some cases, the fluid sources (319a,b) may be the same fluid source providing the same fluid (312a,b), such as air.

The die assemblies (311a,b) may be operatively connected to the extruders (100a,b,c) in a desired orientation, such as a vertical upright position as shown in FIG. 3A, a vertical downward position as shown in FIG. 3B, or a horizontal position as shown in FIG. 1. One or more extruders may be used to provide the polymeric matrix material that forms the layers and one or more material sources, such as extruder (100c) and/or microcapillary fluid source (319b), may be used to provide the microcapillary material. Additionally, as described in more detail below, the die assemblies may be configured in a crosshead position for co-extrusion with a conductor or conductive core.

### Annular Microcapillary Products

FIGS. 4A-4C depict various views of a multi-layer, annular microcapillary product which may be in the form of a film (310, 310′) produced, for example, by the extruders (300a,b) and die assemblies (311a,b) of FIGS. 3A and/or 3B. As shown in FIGS. 4A and 4B, the multi-layer, annular microcapillary product (310) may be similar to the multi-layer film (210), except that the multi-layer, annular microcapillary product (310) is formed from the annular die assemblies (311a,b) into polymeric matrix layers (450a,b) with microcapillaries (303, 303′) therein. The polymeric matrix layers (450a,b) collectively form a polymeric matrix (418) of the annular microcapillary product (310). The layers (450a,b) have substantially parallel, substantially linear channels (320) defining microcapillaries (303) therein.

As shown in FIGS. 4B and 4C, the multi-layer, annular microcapillary product (310, 310′) may be extruded with various microcapillary material (117) or microcapillary fluid (312b) therein. The microcapillaries may be formed in channels (320, 320′) with various cross-sectional shapes. In the example of FIG. 4B, the channels (320) have an arcuate cross-section defining the microcapillaries (303) with the microcapillary material (117) therein. The microcapillary material (117) is in the channels (320) between the matrix layers (450a,b) that form the polymeric matrix (418). The microcapillary material (117) forms a core layer between the polymeric matrix layers (450a,b).

In the example of FIG. 4C, the channels (320′) have another shape, such as an elliptical cross-section defining microcapillaries (303′) with the microcapillary material (312b) therein. The microcapillary material (312b) is depicted as fluid (e.g., air) in the channels (320′) between the layers (450a,b) that form the polymeric matrix (418).

It should be noted that, as with the films described above, the annular microcapillary product can also take the form of a single-layer product when the same matrix material is employed for the layers (450a,b). This is due to the fusion of the two streams of the matrix layers in a molten state merging shortly before exiting the die.

The materials used to form the annular microcapillary products as described herein may be selected for a given application. For example, the material may be a plastic, such as a thermoplastic or thermoset material. When a thermoplastic material is employed, the thermoplastic material (117) forming the polymeric matrix (418) and/or the microcapillary material (117) may be selected from those materials useful in forming the film (210) as described above. Accordingly, the annular microcapillary products may be made of various materials, such as polyolefins (e.g., polyethylene or polypropylene).

Referring to FIG. 5, the fluid source (319a) may pass annular fluid (e.g., air) (312a) through the annular microcapillary product (310a) to support the tubular shape during extrusion. The die assembly (311a) may form the multi-layer, annular microcapillary product (310a,310a′) into a tubular shape as shown in FIGS. 6A-6B.

As also shown by FIGS. 6A and 6B, the thermoplastic materials forming portions of the multi-layer, annular microcapillary product (310a,310a′) may be varied. In the example shown in FIGS. 4A, 4B, and 6A, the layers (450a,b) forming polymeric matrix (418) may have a different material from the microcapillary material (117) in the microcapillaries (303) as schematically indicated by the black channels (320) and white polymeric matrix (418). In another example, as shown in FIG. 6B, the layers (450a,b) forming a polymeric matrix (418) and the material in microcapillaries (303) may be made of the same material, such as low-density polyethylene, such that the polymeric matrix (418) and the channels (320) are both depicted as black.

### Die Assemblies for Annular Microcapillary Products

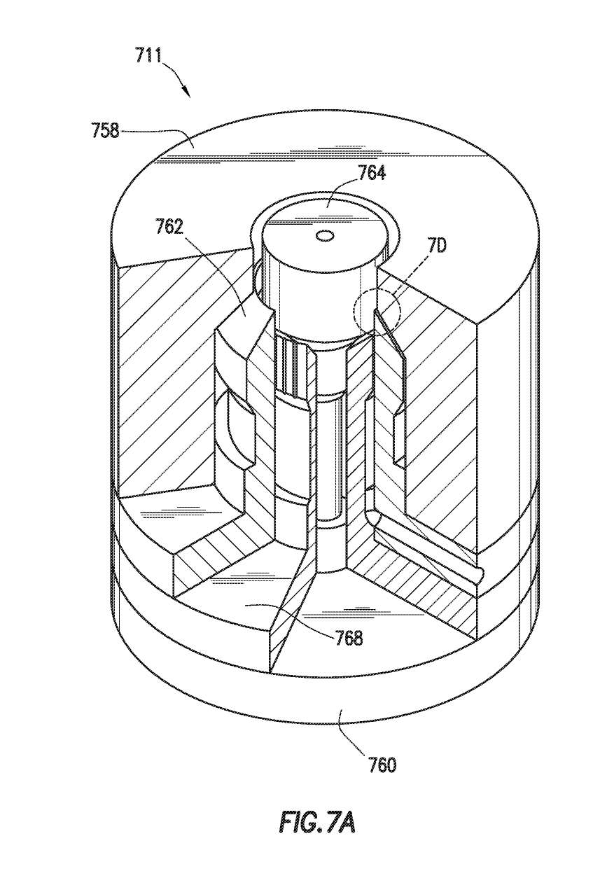

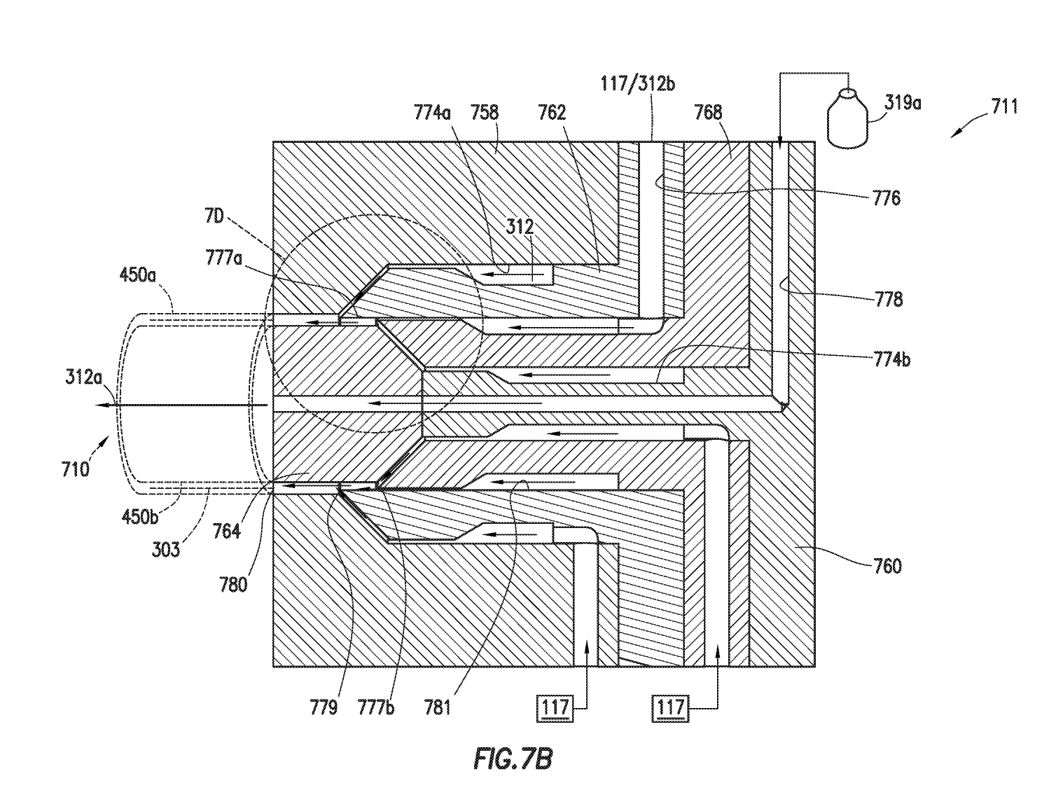

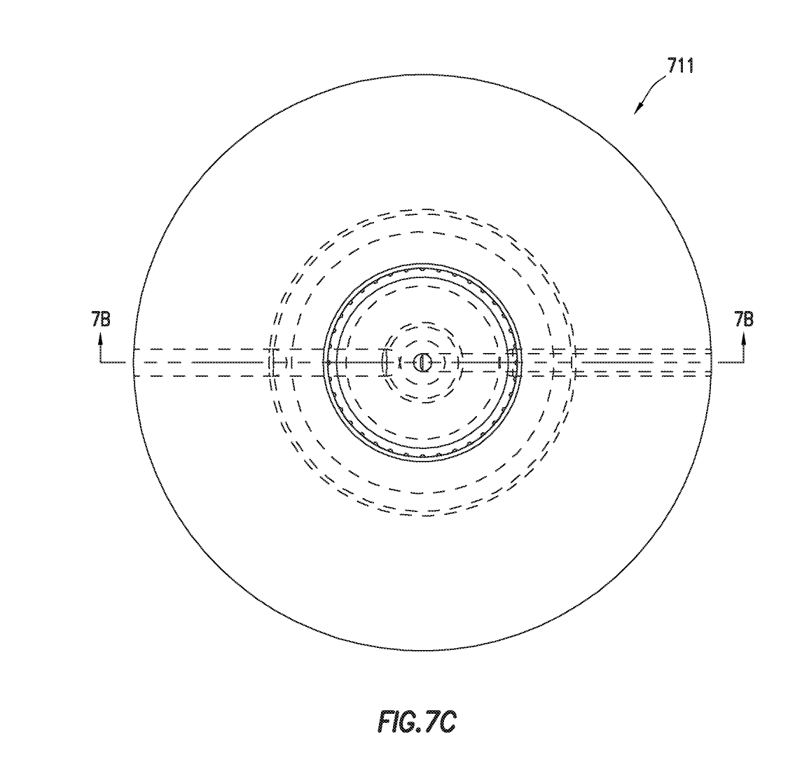

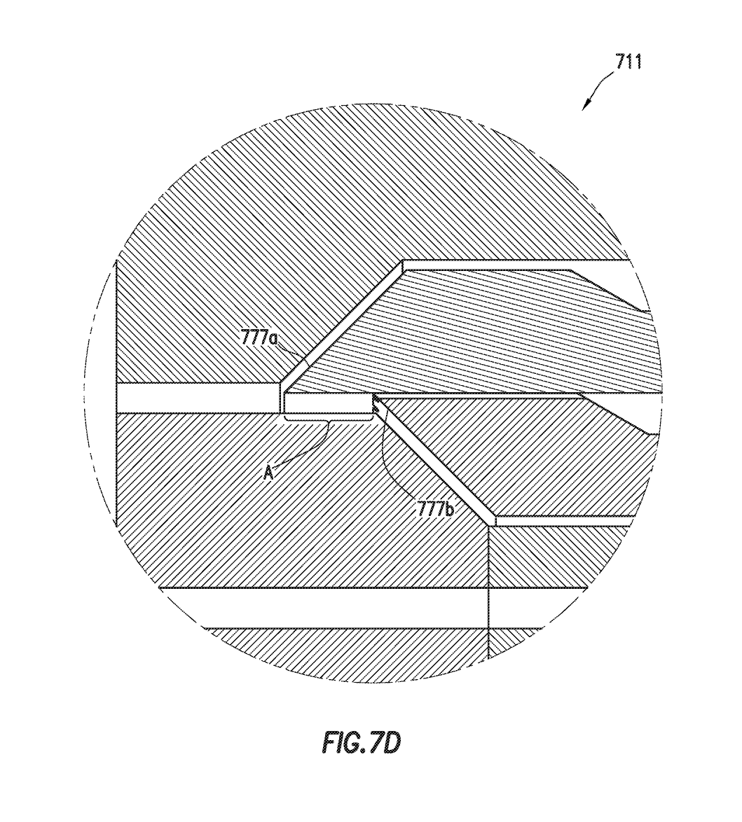

FIGS. 7A-9D depict example configurations of die assemblies (711,811,911) usable as the die assembly (311). While FIGS. 7A-9D show examples of possible die assembly configurations, combinations and/or variations of the various examples may be used to provide the desired multi-layer, annular microcapillary product, such as those shown in the examples of FIGS. 4A-6B.

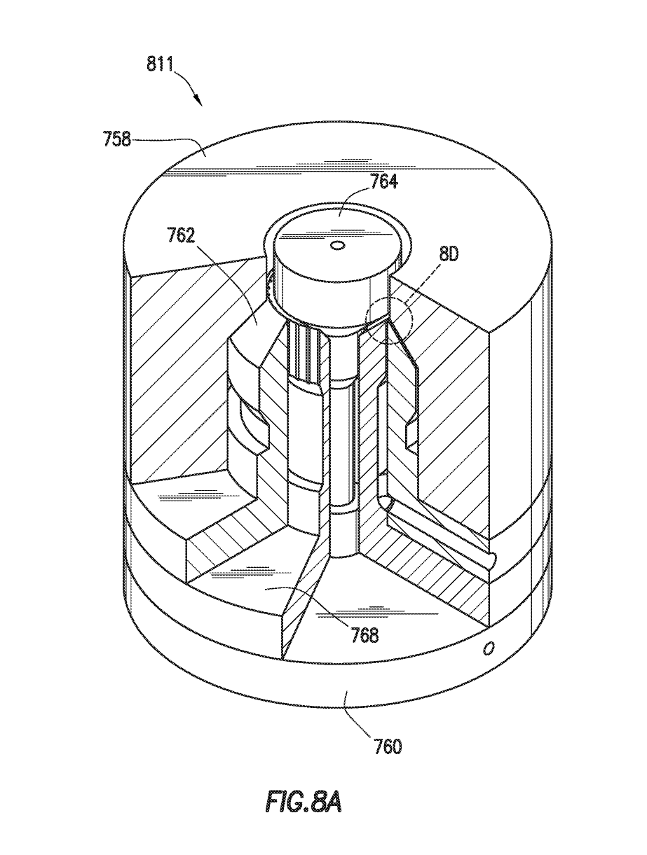

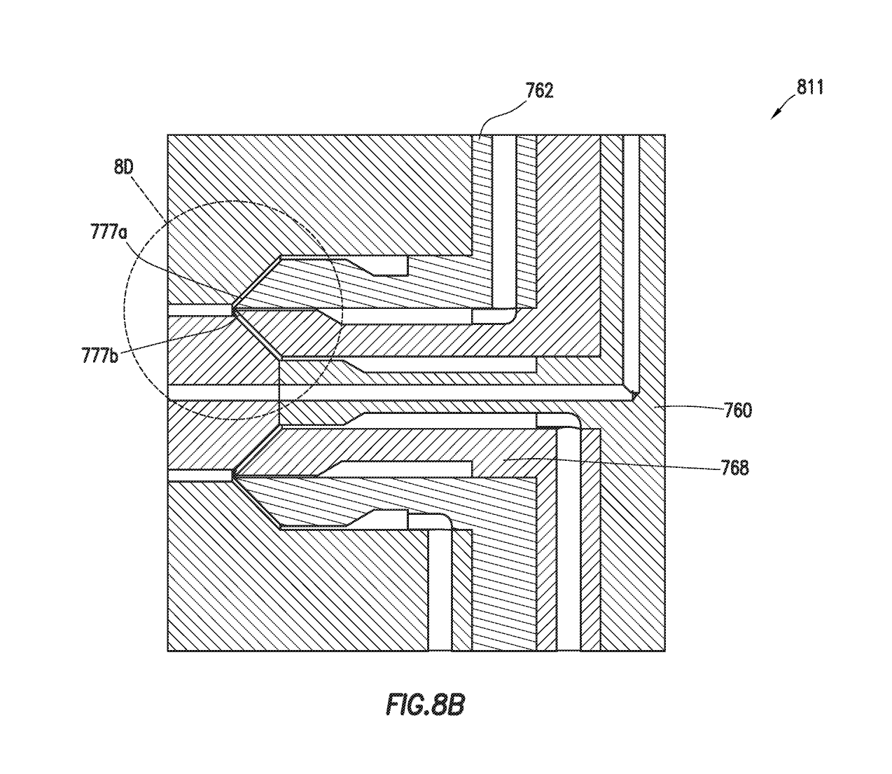

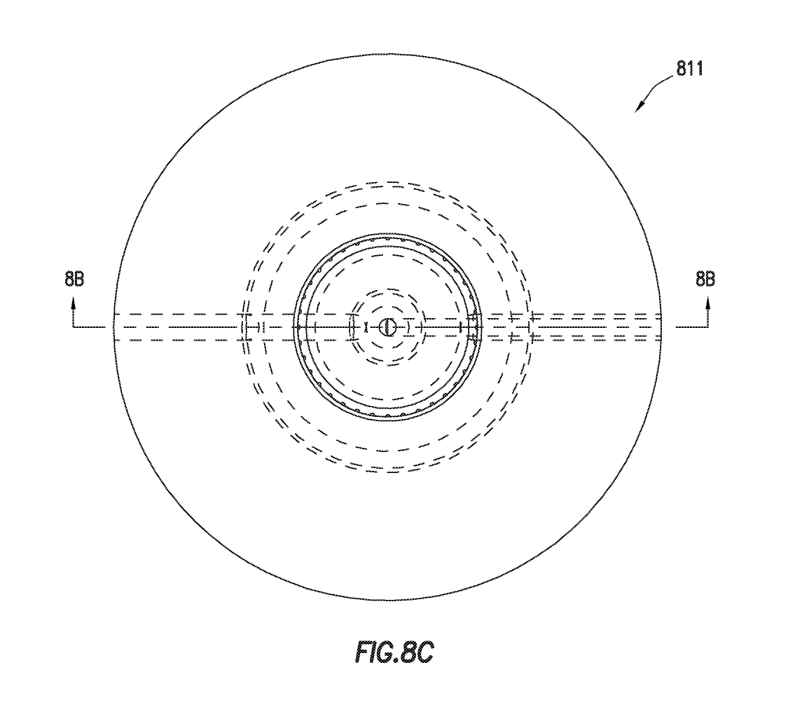

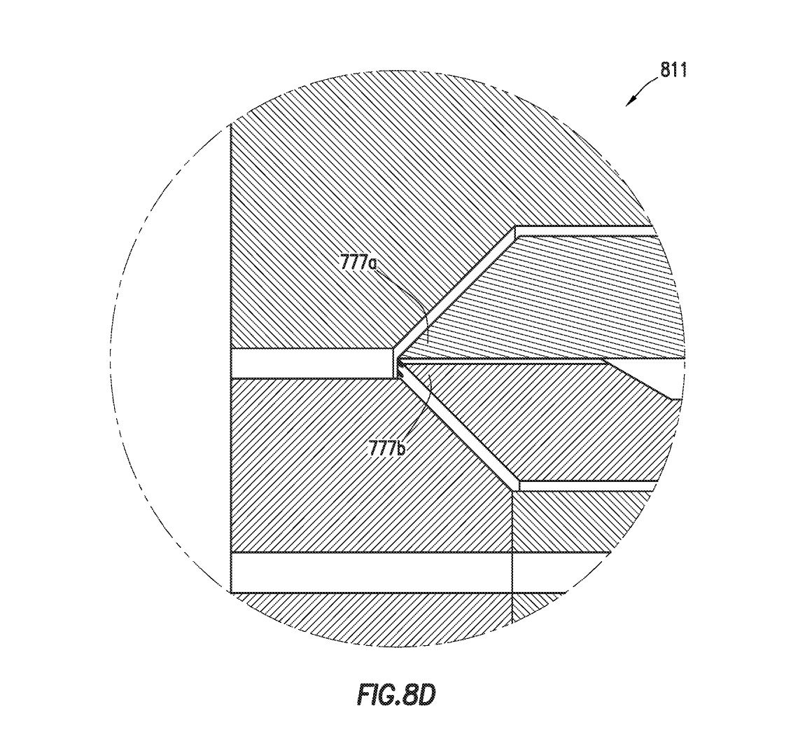

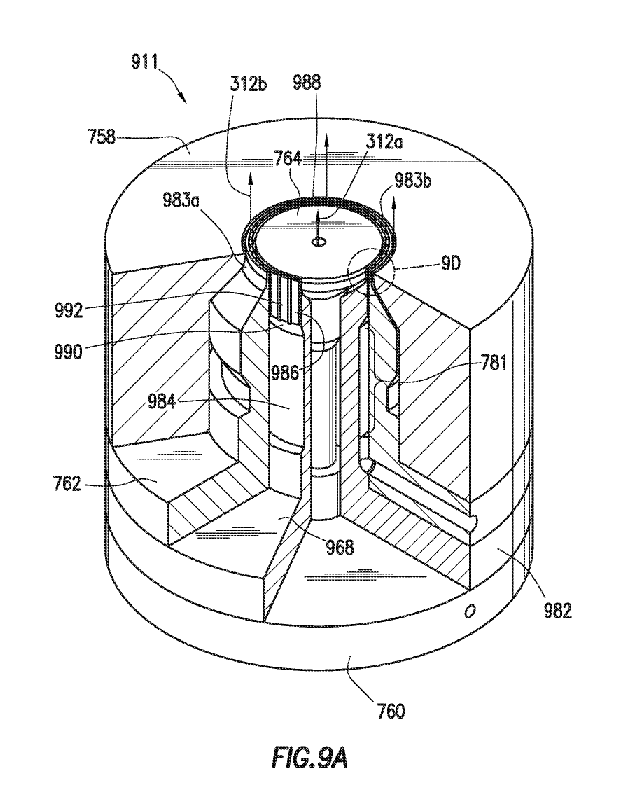

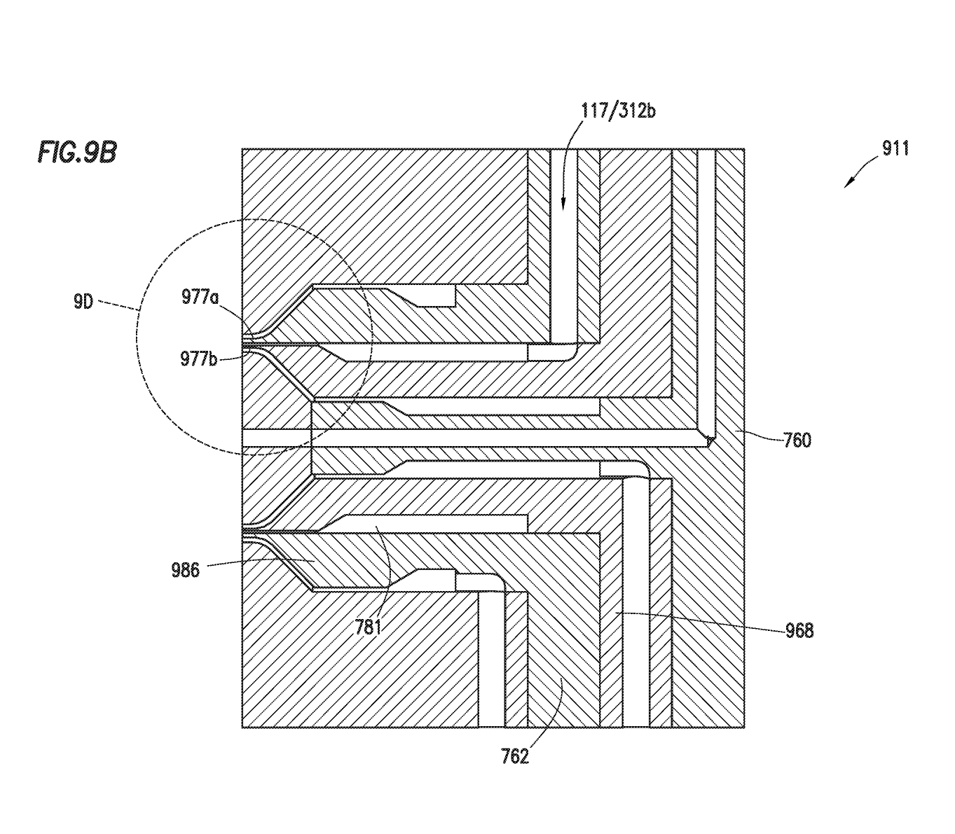

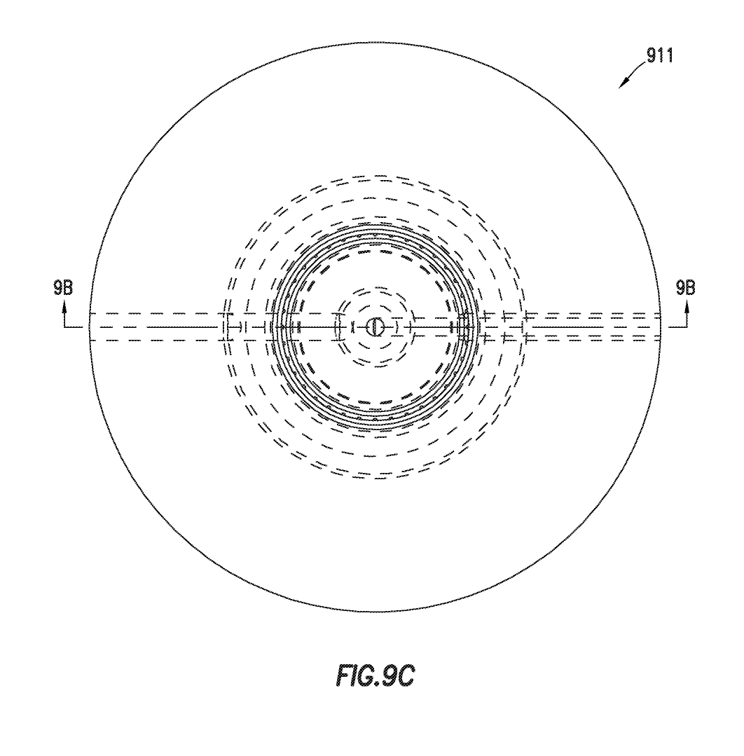

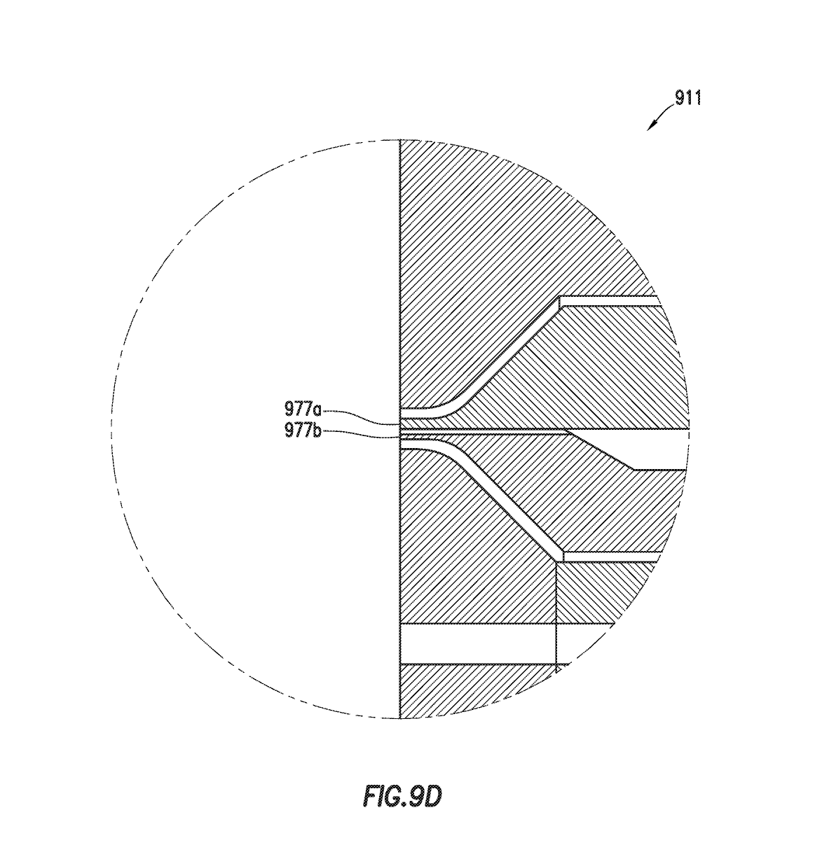

FIGS. 7A-7D depict partial cross-sectional, longitudinal cross-sectional, end, and detailed cross-sectional views, respectively, of the die assembly (711). FIGS. 8A-8D depict partial cross-sectional, longitudinal cross-sectional, end, and detailed cross-sectional views, respectively, of the die assembly (811). FIGS. 9A-9D depict partial cross-sectional, longitudinal cross-sectional, end, and detailed cross-sectional views, respectively, of the die assembly (911). The die assemblies (711, 811) may be used, for example, with the extruder assembly (300a) of FIG. 3A and the die assembly (911) may be used, for example, with the extruder assembly (300b) of FIG. 3B to form multi-layer, annular microcapillary products, such as those described herein.

As shown in FIGS. 7A-7D the die assembly (711) includes a shell (758), an inner manifold (760), an outer manifold (762), a cone (764), and a die insert (768). The shell (758) is a tubular member shaped to receive the outer manifold (762). The outer manifold (762), die insert (768), and the inner manifold (760) are each flange shaped members stacked and concentrically received within the shell (758). While an inner manifold (760) and an outer manifold (762) are depicted, one or more inner and/or outer manifolds or other devices capable of providing flow channels for forming layers of the polymeric matrix may be provided.

The die insert (768) is positioned between the outer manifold (762) and the inner manifold (760). The inner manifold (760) has the cone (764) at an end thereof extending through the die insert (768) and the outer manifold (762) and into the shell (758). The die assembly (711) may be provided with connectors, such as bolts (not shown), to connect portions of the die assembly (711).

Referring now to FIG. 7B, annular matrix channels (774a,b) are defined between the shell (758) and the outer manifold (762) and between the die insert (768) and the inner manifold (760), respectively. The thermoplastic material (117) is depicted passing through the matrix channels (774a,b) as indicated by the arrows to form the layers (450a,b) of the multi-layer, annular microcapillary product (710). The multi-layer, annular microcapillary product (710) may be any of the multi-layer, annular microcapillary products described herein, such as (310a,b).

A microcapillary channel (776) is also defined between the die insert (768) and the outer manifold (762). The microcapillary channel (776) may be coupled to the microcapillary material source for passing the microcapillary material (117,312b) through the die assembly (711) and between the layers (450a,b) to form the microcapillaries (303) therein. The fluid channel (778) extends through the inner manifold (760) and the cone (764). Annular fluid (312a) from fluid source (319a) flows through the fluid channel (778) and into the product (710a,).

The die insert (768) may be positioned concentrically between the inner manifold (760) and the outer manifold (762) to provide uniform distribution of polymer melt flow through the die assembly (711). The die insert (762) may be provided with a distribution channel (781) along an outer surface thereof to facilitate the flow of the microcapillary material (117/312b) therethrough.

The matrix channels (774a,b) and the microcapillary channel (776) converge at convergence (779) and pass through an extrusion outlet (780) such that thermoplastic material flowing through matrix channels (774a,b) forms layers (450a,b) with microcapillary material (117/312b) from microcapillary channel (776) therebetween. The outer manifold (762) and die insert (768) each terminate at an outer nose (777a) and an insert nose (777b), respectively. As shown in FIG. 7D, the outer nose (777a) extends a distance A further toward the extrusion outlet (780) and/or a distance A further away from the extrusion outlet (780) than the nose (777b).

The die assemblies (811, 911) of FIGS. 8A-9D may be similar to the die assembly (711) of FIGS. 7A-7D, except that a position of noses (777a,b, 977a,b) of the die insert (768, 968) relative to the outer manifold (762) may be varied. The position of the noses may be adjusted to define a flow pattern, such as asymmetric or symmetric therethrough. As shown in FIGS. 7A-7D, the die assembly (711) is in an asymmetric flow configuration with nose (777b) of the die insert (768) positioned a distance A from the nose (777a) of the outer manifold (762). As shown in FIGS. 8A-8D, the die assembly (811) is in the symmetric flow configuration with the noses (777a,b) of the die insert (768) and the outer manifold (762) being flush.

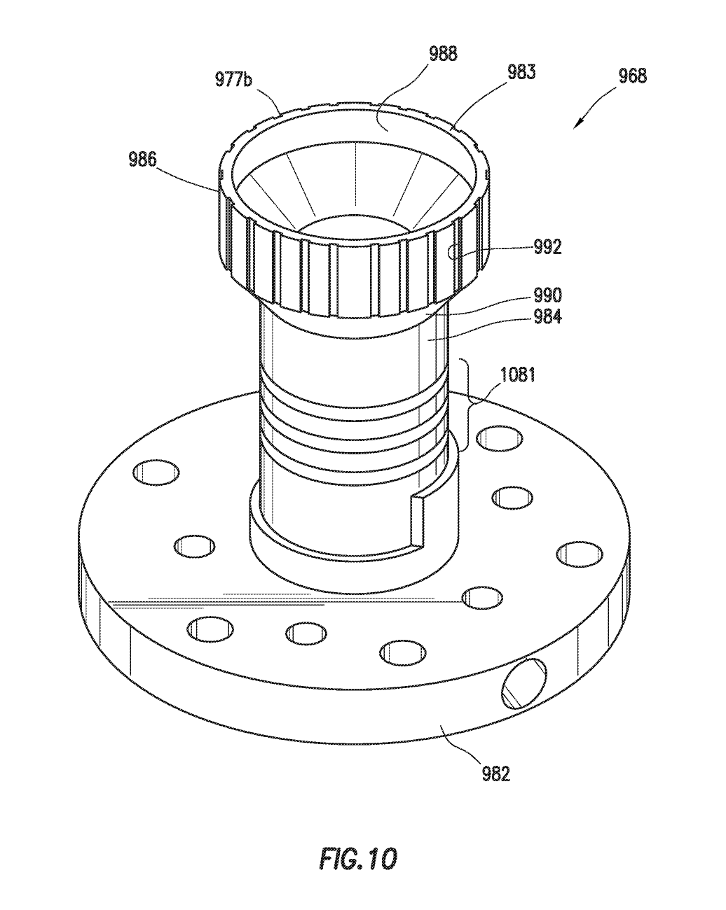

FIGS. 9A-9D and 10 depict an annular die insert (968) provided with features to facilitate the creation of the channels (320), microcapillaries (303), and/or insertion of the microcapillary material (117/312b) therein (see, e.g., FIGS. 4A-4B). The die insert (968) includes a base (982), a tubular manifold (984), and a tip (986). The base (982) is a ring shaped member that forms a flange extending from a support end of the annular microcapillary manifold (984). The base (982) is supportable between the inner manifold (760) and outer manifold (762). The outer manifold (762) has an extended nose (977a) and the die insert (968) has an extended nose (977b) positioned flush to each other to define a symmetric flow configuration through the die assembly (911).

The tip (986) is an annular member at a flow end of the tubular manifold (984). An inner surface of the tip (986) is inclined and shaped to receive an end of the cone (764). The tip (986) has a larger outer diameter than the annular microcapillary manifold (984) with an inclined shoulder (990) defined therebetween. An outer surface of the tip (986) has a plurality of linear, parallel microcapillary flow channels (992) therein for the passage of the microcapillary material (117/312b) therethrough. The outer manifold 762 terminates in a sharp edge (983a) along nose (977a) and tip (986) terminates in a sharp edge (983b) along nose (977b).

The annular microcapillary manifold (984) is an annular member extending between the base (982) and the tip (986). The annular microcapillary manifold (984) is supportable between a tubular portion of the inner manifold (760) and the outer manifold (762). The annular microcapillary manifold (984) has a passage (988) therethrough to receive the inner manifold (760).

The distribution channel (781) may have a variety of configurations. As shown in FIGS. 9A-9D, an outer surface of the annular microcapillary manifold (984) has the distribution channel (781) therealong for the passage of material therethrough. The distribution channel (781) may be in fluid communication with the microcapillary material (117/312b) via the microcapillary channel (776) as schematically depicted in FIG. 9B. The distribution channel (781) may be positioned about the die insert (968) to direct the microcapillary material around a circumference of the die insert (968). The die insert (968) and/or distribution channel (781) may be configured to facilitate a desired amount of flow of microcapillary material (117/312b) through the die assembly. The distribution channel (781) defines a material flow path for the passage of the microcapillary material between the die insert (968) and the outer manifold (762). A small gap may be formed between the die insert (968) and the outer manifold (762) that allows the microcapillary material (117/312b) to leak out of the distribution channel (781) to distribute the microcapillary material (117/312b) uniformly through the die assembly (911). The distribution channel (781) may be in the form of a cavity or channel extending a desired depth into the die insert (968) and/or the outer manifold (760). For example, as shown in FIGS. 7A-9D, the distribution channel (781) may be a space defined between the outer surface of the die insert (968) and the outer manifold (760). As shown in FIG. 10, the distribution channel (781, 1081) is a helical groove extending a distance along the outer surface of the tubular manifold (984). Part or all of the distribution channel (781, 1081) may be linear, curved, spiral, crosshead, and/or combinations thereof.

### Coated Conductor

The above-described annular microcapillary products can be used to prepare coated conductors, such as a cable. “Cable” and “power cable” mean at least one conductor within a sheath, e.g., an insulation covering and/or a protective outer jacket. “Conductor” denotes one or more wire(s) or fiber(s) for conducting heat, light, and/or electricity. The conductor may be a single-wire/fiber or a multi-wire/fiber and may be in strand form or in tubular form. Non-limiting examples of suitable conductors include metals such as silver, gold, copper, carbon, and aluminum. The conductor may also be optical fiber made from either glass or plastic. “Wire” means a single strand of conductive metal, e.g., copper or aluminum, or a single strand of optical fiber. Typically, a cable is two or more wires or optical fibers bound together, often in a common insulation covering and/or protective jacket. The individual wires or fibers inside the sheath may be bare, covered or insulated. Combination cables may contain both electrical wires and optical fibers. When the cable is a power cable, the cable can be designed for low, medium, and/or high voltage applications. Typical cable designs are illustrated in U.S. Pat. Nos. 5,246,783, 6,496,629 and 6,714,707. When the cable is a telecommunication cable, the cable can be designed for telephone, local area network (LAN)/data, coaxial CATV, coaxial RF cable or a fiber optic cable.

The above-described annular microcapillary products can constitute at least one polymeric coating layer in a cable, which is elongated in the same direction of elongation as the conductor or conductive core of the cable. As such, the polymeric coating can surround at least a portion of the conductor. In surrounding the conductor, the polymeric coating can be either in direct contact with the conductor or can be in indirect contact with the conductor by being placed on one or more interceding layers between the conductor and the polymeric coating. The polymeric coating comprises a polymeric matrix material and a plurality of microcapillaries which extend substantially in the direction of elongation of the polymeric coating. In various embodiments, the microcapillaries can be radially placed around the polymeric coating. Additionally, the microcapillaries can be spaced apart equidistantly or substantially equidistantly relative to one another.

One or more of the above-described die assemblies for producing annular microcapillary products can be modified to permit a conductor to pass therethrough, thereby allowing the polymeric coating comprising a polymeric matrix material and a plurality of microcapillaries to be coextruded onto the conductor or an interceding layer. Such a configuration is commonly known in the art as a crosshead die (see, e.g., US 2008/0193755 A1, US 2014/0072728 A1, and US 2013/0264092 A1). Specifically, the inner manifold (760) and cone (764) in FIGS. 7A, 8A and 9A can be modified to create a wire- or conductor-passing hole. As one of ordinary skill in the art would recognize, all the parts close to the die exit can be modified such that the multilayer extrusion materials are able to coat onto a conductor or interceding layer, traveling through the wire- or conductor-passing hole. An additional part with molding passage can be fabricated. Such modifications are within the capabilities of one having ordinary skill in the art.

In an exemplary microcapillary extrusion coating process, a conductor core through an extrusion coating equipment can be pulled by a retractor to continuously move through the wire-passing hole of the inner manifold (760) to go through the projection end and then pass through the molding passage of the outer die. While the conductor core is moving, the polymer melt is injected by pressure into the material-supplying passages, flows toward to the wiring coating passage, and then into the molding passage at the outlet to coat onto the outer surface of the conductor core which is passing through the molding passage. Subsequently, the coated conductor core continues to move through the molding passage to outside the die, and then it can be cooled and hardened.

In preparing the polymeric coating, any of the above-described polymers can be used as the polymeric matrix material. In various embodiments, the polymeric matrix material can be a thermoplastic polymer. Examples of such thermoplastic polymers include, but are not limited to, ethylene-based polymers (e.g., polyethylene), polyesters (e.g., polyethylene terephthalate, polybutylene terephthalate), polyamides (e.g., nylon), and polycarbonates. Additionally, the polymeric matrix material can be crosslinkable, or, in a finished cable construction, a crosslinked polymer (e.g., crosslinked polyethylene).

In various embodiments, the polymer employed as the polymeric matrix material can comprise an ethylene-based polymer. As used herein, “ethylene-based” polymers are polymers prepared from ethylene monomers as the primary (i.e., greater than 50 weight percent (“wt %”)) monomer component, though other co-monomers may also be employed. “Polymer” means a macromolecular compound prepared by reacting (i.e., polymerizing) monomers of the same or different type, and includes homopolymers and interpolymers. “Interpolymer” means a polymer prepared by the polymerization of at least two different monomer types. This generic term includes copolymers (usually employed to refer to polymers prepared from two different monomer types), and polymers prepared from more than two different monomer types (e.g., terpolymers (three different monomer types) and tetrapolymers (four different monomer types)).

In various embodiments, the ethylene-based polymer can be an ethylene homopolymer. As used herein, “homopolymer” denotes a polymer comprising repeating units derived from a single monomer type, but does not exclude residual amounts of other components used in preparing the homopolymer, such as chain transfer agents.

In an embodiment, the ethylene-based polymer can be an ethylene/alphα-olefin (“α olefin”) interpolymer having an α-olefin content of at least 1 wt %, at least 5 wt %, at least 10 wt %, at least 15 wt %, at least 20 wt %, or at least 25 wt % based on the entire interpolymer weight. These interpolymers can have an α-olefin content of less than 50 wt %, less than 45 wt %, less than 40 wt %, or less than 35 wt % based on the entire interpolymer weight. When an α-olefin is employed, the α-olefin can be a C3-20 (i.e., having 3 to 20 carbon atoms) linear, branched or cyclic α-olefin. Examples of C3-20 α-olefins include propene, 1 butene, 4-methyl-1-pentene, 1-hexene, 1-octene, 1-decene, 1 dodecene, 1 tetradecene, 1 hexadecene, and 1-octadecene. The α-olefins can also have a cyclic structure such as cyclohexane or cyclopentane, resulting in an α-olefin such as 3 cyclohexyl-1-propene (allyl cyclohexane) and vinyl cyclohexane. Illustrative ethylene/α-olefin interpolymers include ethylene/propylene, ethylene/1-butene, ethylene/1 hexene, ethylene/1 octene, ethylene/propylene/1-octene, ethylene/propylene/1-butene, and ethylene/1-butene/1 octene.

Ethylene-based polymers also include interpolymers of ethylene with one or more unsaturated acid or ester monomers, such as unsaturated carboxylic acids or alkyl (alkyl)acrylates. Such monomers include, but are not limited to, vinyl acetate, methyl acrylate, methyl methacrylate, ethyl acrylate, ethyl methacrylate, butyl acrylate, acrylic acid, and the like. Accordingly, ethylene-based polymers can include interpolymers such as poly(ethylene-co-methyl acrylate) (“EMA”), poly(ethylene-co-ethyl acrylate) (“EEA”), poly(ethylene-co-butyl acrylate) (“EBA”), and poly(ethylene-co-vinyl acetate) (“EVA”).

In various embodiments, the ethylene-based polymer can be used alone or in combination with one or more other types of ethylene-based polymers (e.g., a blend of two or more ethylene-based polymers that differ from one another by monomer composition and content, catalytic method of preparation, etc). If a blend of ethylene-based polymers is employed, the polymers can be blended by any in-reactor or post-reactor process.

In an embodiment, the ethylene-based polymer can be a low-density polyethylene (“LDPE”). LDPEs are generally highly branched ethylene homopolymers, and can be prepared via high pressure processes (i.e., HP-LDPE). LDPEs suitable for use herein can have a density ranging from 0.91 to 0.94 g/cm³. In various embodiments, the ethylene-based polymer is a high-pressure LDPE having a density of at least 0.915 g/cm³, but less than 0.94 g/cm³, or in the range of from 0.924 to 0.938 g/cm³. Polymer densities provided herein are determined according to ASTM International (“ASTM”) method D792. LDPEs suitable for use herein can have a melt index (I₂) of less than 20 g/10 min., or ranging from 0.1 to 10 g/10 min., from 0.5 to 5 g/10 min., from 1 to 3 g/10 min., or an 12 of 2 g/10 min. Melt indices provided herein are determined according to ASTM method D1238. Unless otherwise noted, melt indices are determined at 190° C. and 2.16 Kg (i.e., 12). Generally, LDPEs have a broad molecular weight distribution (“MWD”) resulting in a relatively high polydispersity index (“PDI;” ratio of weight-average molecular weight to number-average molecular weight).

In an embodiment, the ethylene-based polymer can be a linear-low-density polyethylene (“LLDPE”). LLDPEs are generally ethylene-based polymers having a heterogeneous distribution of comonomer (e.g., α-olefin monomer), and are characterized by short-chain branching. For example, LLDPEs can be copolymers of ethylene and α-olefin monomers, such as those described above. LLDPEs suitable for use herein can have a density ranging from 0.916 to 0.925 g/cm³. LLDPEs suitable for use herein can have a melt index (I₂) ranging from 1 to 20 g/10 min., or from 3 to 8 g/10 min.

In an embodiment, the ethylene-based polymer can be a very-low-density polyethylene (“VLDPE”). VLDPEs may also be known in the art as ultra-low-density polyethylenes, or ULDPEs. VLDPEs are generally ethylene-based polymers having a heterogeneous distribution of comonomer (e.g., α-olefin monomer), and are characterized by short-chain branching. For example, VLDPEs can be copolymers of ethylene and α-olefin monomers, such as one or more of those α-olefin monomers described above. VLDPEs suitable for use herein can have a density ranging from 0.87 to 0.915 g/cm³. VLDPEs suitable for use herein can have a melt index (I₂) ranging from 0.1 to 20 g/10 min., or from 0.3 to 5 g/10 min.

In an embodiment, the ethylene-based polymer can be a medium-density polyethylene (“MDPE”). MDPEs are ethylene-based polymers having densities generally ranging from 0.926 to 0.950 g/cm³. In various embodiments, the MDPE can have a density ranging from 0.930 to 0.949 g/cm³, from 0.940 to 0.949 g/cm³, or from 0.943 to 0.946 g/cm³. The MDPE can have a melt index (I₂) ranging from 0.1 g/10 min, or 0.2 g/10 min, or 0.3 g/10 min, or 0.4 g/10 min, up to 5.0 g/10 min, or 4.0 g/10 min, or, 3.0 g/10 min or 2.0 g/10 min, or 1.0 g/10 min, as determined according to ASTM D-1238 (190° C./2.16 kg).

In an embodiment, the ethylene-based polymer can be a high-density polyethylene (“HDPE”). HDPEs are ethylene-based polymers generally having densities greater than 0.940 g/cm³. In an embodiment, the HDPE has a density from 0.945 to 0.97 g/cm³, as determined according to ASTM D-792. The HDPE can have a peak melting temperature of at least 130° C., or from 132 to 134° C. The HDPE can have a melt index (I₂) ranging from 0.1 g/10 min, or 0.2 g/10 min, or 0.3 g/10 min, or 0.4 g/10 min, up to 5.0 g/10 min, or 4.0 g/10 min, or, 3.0 g/10 min or 2.0 g/10 min, or 1.0 g/10 min, or 0.5 g/10 min, as determined according to ASTM D-1238 (190° C./2.16 kg). Also, the HDPE can have a PDI in the range of from 1.0 to 30.0, or in the range of from 2.0 to 15.0, as determined by gel permeation chromatography.

In an embodiment, the ethylene-based polymer can comprise a combination of any two or more of the above-described ethylene-based polymers.

In an embodiment, the polymeric matrix material can comprise LDPE. In an embodiment, the polymeric matrix material is LDPE.

In an embodiment, the polymeric matrix material can comprise MDPE. In an embodiment, the polymeric matrix material is MDPE.

Production processes used for preparing ethylene-based polymers are wide, varied, and known in the art. Any conventional or hereafter discovered production process for producing ethylene-based polymers having the properties described above may be employed for preparing the ethylene-based polymers described herein. In general, polymerization can be accomplished at conditions known in the art for Ziegler-Natta or Kaminsky-Sinn type polymerization reactions, that is, at temperatures from 0 to 250° C., or 30 or 200° C., and pressures from atmospheric to 10,000 atmospheres (1,013 megaPascal (“MPa”)). In most polymerization reactions, the molar ratio of catalyst to polymerizable compounds employed is from 10-12:1 to 10 1:1, or from 10-9:1 to 10-5:1.

Examples of suitable commercially available ethylene-based polymers include, but are not limited to AXELERON™ GP C-0588 BK (LDPE), AXELERON™ FO 6548 BK (MDPE), AXELERON™ GP A-7530 NT (LLDPE), AXELERON™ GP G-6059 BK (LLDPE), AXELERON™ GP K-3479 BK (HDPE), AXELERON™ GP A-1310 NT (HDPE), and AXELERON™ FO B-6549 NT (MDPE), all of which are commercially available from The Dow Chemical Company, Midland, Mich., USA.

Examples of suitable polypropylene-based polymers, such as homopolymer, random copolymer, heterophasic copolymer, and high-crystalline homopolymer polypropylenes are commercially available from Braskem Corp.

In preparing the polymeric coating the microcapillary material can be an elastomeric microcapillary material. As known in the art, elastomers are defined as materials which experience large reversible deformations under relatively low stress. In various embodiments, the elastomeric microcapillary material can have a lower flexural modulus than the polymeric matrix material. Further, the elastomeric microcapillary material can have a flexural modulus that is at least 5%, at least 10%, at least 20%, or at least 50%, less than the flexural modulus of the polymeric matrix material. In any embodiments where the microcapillaries are filled with a polymeric microcapillary material, the microcapillaries can define individual, discrete polymer-filled segments which are completely surrounded by the polymeric matrix material when viewed as a cross-section taken orthogonal to the direction of elongation of the microcapillaries.

In various embodiments, the elastomer can be an olefin elastomer. Olefin elastomers include both polyolefin homopolymers and interpolymers. Examples of the polyolefin interpolymers are ethylene/α-olefin interpolymers and propylene/α-olefin interpolymers. In such embodiments, the α-olefin can be a C₃₋₂₀ linear, branched or cyclic α-olefin (for the propylene/α-olefin interpolymers, ethylene is considered an α-olefin). Examples of C₃₋₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins can also contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this invention certain cyclic olefins, such as norbornene and related olefins, are α-olefins and can be used in place of some or all of the α-olefins described above. Similarly, styrene and its related olefins (for example, α-methylstyrene, etc.) are α-olefins for purposes of this invention. Illustrative polyolefin copolymers include ethylene/propylene, ethylene/butene, ethylene/1-hexene, ethylene/1-octene, ethylene/styrene, and the like. Illustrative terpolymers include ethylene/propylene/1-octene, ethylene/propylene/butene, ethylene/butene/1-octene, and ethylene/butene/styrene. The copolymers can be random or blocky.

Olefin elastomers can also comprise one or more functional groups such as an unsaturated ester or acid or silane, and these elastomers (polyolefins) are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 1 up to 50 percent by weight based on the weight of the copolymer. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Examples of the unsaturated acids include acrylic acids or maleic acids. One example of an unsaturated silane is vinyl trialkoxysilane.

Functional groups can also be included in the olefin elastomer through grafting which can be accomplished as is commonly known in the art. In one embodiment, grafting may occur by way of free radical functionalization which typically includes melt blending an olefin polymer, a free radical initiator (such as a peroxide or the like), and a compound containing a functional group. During melt blending, the free radical initiator reacts (reactive melt blending) with the olefin polymer to form polymer radicals. The compound containing a functional group bonds to the backbone of the polymer radicals to form a functionalized polymer. Exemplary compounds containing functional groups include but are not limited to alkoxysilanes, e.g., vinyl trimethoxysilane, vinyl triethoxysilane, and vinyl carboxylic acids and anhydrides, e.g., maleic anhydride.

More specific examples of the olefin elastomers useful in this invention include very-low-density polyethylene (“VLDPE”) (e.g., FLEXOMER™ ethylene/1-hexene polyethylene made by The Dow Chemical Company), homogeneously branched, linear ethylene/α-olefin copolymers (e.g. TAFMER™ by Mitsui Petrochemicals Company Limited and EXACT™ by Exxon Chemical Company), and homogeneously branched, substantially linear ethylene/α-olefin polymers (e.g., AFFINITY™ and ENGAGE™ polyethylene available from The Dow Chemical Company).

The olefin elastomers useful herein also include propylene, butene, and other alkene-based copolymers, e.g., copolymers comprising a majority of units derived from propylene and a minority of units derived from another α-olefin (including ethylene). Exemplary propylene polymers useful herein include VERSIFY™ polymers available from The Dow Chemical Company, and VISTAMAXX™ polymers available from ExxonMobil Chemical Company.

Olefin elastomers can also include ethylene-propylene-diene monomer (“EPDM”) elastomers and chlorinated polyethylenes (“CPE”). Commercial examples of suitable EPDMs include NORDEL™ EPDMs, available from The Dow Chemical Company. Commercial examples of suitable CPEs include TYRIN™ CPEs, available from The Dow Chemical Company.

Olefin elastomers, particularly ethylene elastomers, can have a density of less than 0.91 g/cm³ or less than 0.90 g/cm³. Ethylene copolymers typically have a density greater than 0.85 g/cm³ or greater than 0.86, g/cm³.

Ethylene elastomers can have a melt index (I₂) greater than 0.10 g/10 min., or greater than 1 g/10 min. Ethylene elastomers can have a melt index of less than 500 g/10 min. or less than 100 g/10 min.

Other suitable olefin elastomers include olefin block copolymers (such as those commercially available under the trade name INFUSE™ from The Dow Chemical Company, Midland, Mich., USA), mesophase-separated olefin multi-block interpolymers (such as described in U.S. Pat. No. 7,947,793), and olefin block composites (such as described in U.S. Patent Application Publication No. 2008/0269412, published on Oct. 30, 2008).

In various embodiments, the elastomer useful as the microcapillary material can be a non-olefin elastomer. Non-olefin elastomers useful herein include silicone and urethane elastomers, styrene-butadiene rubber (“SBR”), nitrile rubber, chloroprene, fluoroelastomers, perfluoroelastomers, polyether block amides and chlorosulfonated polyethylene. Silicone elastomers are polyorganosiloxanes typically having an average unit formula RₐSiO_{(4-a)/2} which may have a linear or partially-branched structure, but is preferably linear. Each R may be the same or different. R is a substituted or non-substituted monovalent hydrocarbyl group which may be, for example, an alkyl group, such as methyl, ethyl, propyl, butyl, and octyl groups; aryl groups such as phenyl and tolyl groups; aralkyl groups; alkenyl groups, for example, vinyl, allyl, butenyl, hexenyl, and heptenyl groups; and halogenated alkyl groups, for example chloropropyl and 3,3,3-trifluoropropyl groups. The polyorganosiloxane may be terminated by any of the above groups or with hydroxyl groups. When R is an alkenyl group the alkenyl group is preferably a vinyl group or hexenyl group. Indeed alkenyl groups may be present in the polyorganosiloxane on terminal groups and/or polymer side chains.

Representative silicone rubbers or polyorganosiloxanes include, but are not limited to, dimethylvinylsiloxy-terminated polydimethylsiloxane, trimethylsiloxy-terminated polydimethylsiloxane, trimethylsiloxy-terminated copolymer of methylvinylsiloxane and dimethylsiloxane, dimethylvinylsiloxy-terminated copolymer of methylvinylsiloxane and dimethylsiloxane, dimethylhydroxysiloxy-terminated polydimethylsiloxane, dimethylhydroxysiloxy-terminated copolymer of methylvinylsiloxane and dimethylsiloxane, methylvinylhydroxysiloxy-terminated copolymer of methylvinylsiloxane and dimethylsiloxane, dimethylhexenylsiloxy-terminated polydimethylsiloxane, trimethylsiloxy-terminated copolymer of methylhexenylsiloxane and dimethylsiloxane, dimethylhexenylsiloxy-terminated copolymer of methylhexenylsiloxane and dimethylsiloxane, dimethylvinylsiloxy-terminated copolymer of methylphenylsiloxane and dimethylsiloxane, dimethylhexenylsiloxy-terminated copolymer of methylphenylsiloxane and dimethylsiloxane, dimethylvinylsiloxy-terminated copolymer of methyl(3,3,3-trifluoropropyl)siloxane and dimethylsiloxane, and dimethylhexenylsiloxy-terminated copolymer of methyl(3,3,3-trifluoropropyl)siloxane and dimethylsiloxane.

Urethane elastomers are prepared from reactive polymers such as polyethers and polyesters and isocyanate functional organic compounds. One typical example is the reaction product of a dihydroxy functional polyether and/or a trihydroxy functional polyether with toluene diisocyanate such that all of the hydroxy is reacted to form urethane linkages leaving isocyanate groups for further reaction. This type of reaction product is termed a prepolymer which may cure by itself on exposure to moisture or by the stoichiometric addition of polycarbinols or other polyfunctional reactive materials which react with isocyanates. The urethane elastomers are commercially prepared having various ratios of isocyanate compounds and polyethers or polyesters.

The most common urethane elastomers are those containing hydroxyl functional polyethers or polyesters and low molecular weight polyfunctional, polymeric isocyanates. Another common material for use with hydroxyl functional polyethers and polyesters is toluene diisocyanate.

Nonlimiting examples of suitable urethane rubbers include the PELLETHANE™ thermoplastic polyurethane elastomers available from the Lubrizol Corporation; ESTANE™ thermoplastic polyurethanes, TECOFLEX™ thermoplastic polyurethanes, CARBOTHANE™ thermoplastic polyurethanes, TECOPHILIC™ thermoplastic polyurethanes, TECOPLAST™ thermoplastic polyurethanes, and TECOTHANE™ thermoplastic polyurethanes, all available from Noveon; ELASTOLLAN™ thermoplastic polyurethanes and other thermoplastic polyurethanes available from BASF; and additional thermoplastic polyurethane materials available from Bayer, Huntsman, Lubrizol Corporation, Merquinsa and other suppliers. Preferred urethane rubbers are those so-called “millable” urethanes such as MILLATHANE™ grades from TSI Industries.

Additional information on such urethane materials can be found in Golding, Polymers and Resins, Van Nostrande, 1959, pages 325 et seq. and Saunders and Frisch, Polyurethanes, Chemistry and Technology, Part II, Interscience Publishers, 1964, among others.

Suitable commercially available elastomers for use as the microcapillary material include, but are not limited to, ENGAGE™ polyolefin elastomers available from The Dow Chemical Company, Midland, Mich., USA. A specific example of such an elastomer is ENGAGE™ 8200, which is an ethylene/octene copolymer having a melt index (I₂) of 5.0 and a density of 0.870 g/cm³.

In embodiments where an elastomer microcapillary material is employed, it may be desirable for the matrix material to have higher toughness, abrasion resistance, density, and/or flexural modulus relative to the elastomer. This is particularly true when the polymeric coating is employed as a jacket (i.e., the outermost layer of the cable construction). This combination affords a polymeric coating having a tough outer layer but with increased flexibility compared to a coating formed completely of the same matrix material. For example, in various embodiments, the polymeric coating can have one or more of the above-described elastomers as the microcapillary material with an ethylene-based polymer, a polyamide (e.g., nylon), a polyester (e.g., polybutylene terephthalate (“PBT”), polyethylene terephthalate (“PET”)), a polycarbonate, or combinations of two or more thereof as the polymeric matrix material. In various embodiments, the polymeric coating can comprise an olefin elastomer as the microcapillary material and the polymeric matrix material can be selected from the group consisting of HDPE, MDPE, LLDPE, LDPE, a polyamide, PBT, PET, a polycarbonate, or combinations of two or more thereof. In one or more embodiments, the microcapillary material can comprise an ethylene/octene copolymer olefin elastomer and the polymeric matrix material can comprise MDPE.

The above-described polymeric matrix material, microcapillary material, or both can contain one or more additives, such as those typically used in preparing cable coatings. For example, the polymeric matrix material, microcapillary material, or both can optionally contain a non-conductive carbon black commonly used in cable jackets. In various embodiments, the amount of a carbon black in the composition can be greater than zero (>0), typically from 1, more typically from 2, and up to 3 wt %, based on the total weight of the composition. In various embodiments, the composition can optionally include a conductive filler, such as a conductive carbon black, metal fibers, powders, or carbon nanotubes, at a high level for semiconductive applications.

Non-limiting examples of conventional carbon blacks include the grades described by ASTM N550, N472, N351, N110 and N660, Ketjen blacks, furnace blacks and acetylene blacks. Other non-limiting examples of suitable carbon blacks include those sold under the tradenames BLACK PEARLS®, CSX®, ELFTEX®, MOGUL®, MONARCH®, REGAL® and VULCAN®, available from Cabot.

The polymeric matrix material, microcapillary material, or both can optionally contain one or more additional additives, which are generally added in conventional amounts, either neat or as part of a masterbatch. Such additives include, but not limited to, flame retardants, processing aids, nucleating agents, foaming agents, crosslinking agents, adhesion modifiers, fillers, pigments or colorants, coupling agents, antioxidants, ultraviolet stabilizers (including UV absorbers), tackifiers, scorch inhibitors, antistatic agents, plasticizers, lubricants, viscosity control agents, anti-blocking agents, surfactants, extender oils, acid scavengers, metal deactivators, vulcanizing agents, and the like.

As noted above, in one or more embodiments the polymeric matrix material can be crosslinkable. Any suitable methods known in the art can be used to crosslink the matrix material. Such methods include, but are not limited to, peroxide crosslinking, silane functionalization for moisture crosslinking, UV crosslinking, or e-beam cure. Such crosslinking methods may require the inclusion of certain additives (e.g., peroxides), as known in the art.

In various embodiments, the polymeric matrix material, the microcapillary material, or both can contain one or more adhesion modifiers. Adhesion modifiers may be helpful in improving interfacial adhesion between the matrix material and the microcapillary material. Any known or hereafter discovered additive that improves adhesion between two polymeric materials may be used herein. Specific examples of suitable adhesion modifiers include, but are not limited to, maleic anhydride (“MAH”) grafted resins (e.g., MAH-grafted polyethylene, MAH-grafted ethylene vinyl acetate, MAH-grafted polypropylene), aminated polymers (e.g., amino-functionalized polyethylene), and the like, and combinations of two or more thereof. MAH-grafted resins are commercially available under the AMPLIFY™ GR trade name from The Dow Chemical Company (Midland, Mich., USA) and under the FUSABOND™ trade name from DuPont (Wilmington, Del., USA).

Non-limiting examples of flame retardants include, but are not limited to, aluminum hydroxide and magnesium hydroxide.

Non-limiting examples of processing aids include, but are not limited to, fatty amides such as stearamide, oleamide, erucamide, or N,N′ ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids; polysiloxanes; and fluoroelastomers such as Viton® available from Dupont Performance Elastomers LLC, or Dynamar™ available from Dyneon LLC.

A non-limiting example of a nucleating agent include Hyperform® HPN-20E (1,2 cyclohexanedicarboxylic acid calcium salt with zinc stearate) from Milliken Chemicals, Spartanburg, S.C.

Non-limiting examples of fillers include, but are not limited to, various flame retardants, clays, precipitated silica and silicates, fumed silica, metal sulfides and sulfates such as molybdenum disulfide and barium sulfate, metal borates such as barium borate and zinc borate, metal anhydrides such as aluminum anhydride, ground minerals, and elastomeric polymers such as EPDM and EPR. If present, fillers are generally added in conventional amounts, e.g., from 5 wt % or less to 50 or more wt % based on the weight of the composition.

In various embodiments, the polymeric coating on the coated conductor can have a thickness ranging from 100 to 3,000 μm, from 500 to 3,000 μm, from 100 to 2,000 μm, from 100 to 1,000 μm, from 200 to 800 μm, from 200 to 600 μm, from 300 to 1,000 μm, from 300 to 900 μm, or from 300 to 700 μm.

Additionally, the average diameter of the microcapillaries in the polymeric coating can be at least 50 μm, at least 100 μm, or at least 250 μm. Additionally, the microcapillaries in the polymeric coating can have an average diameter in the range of from 50 to 1,990 μm, from 50 to 990 μm, from 50 to 890 μm, from 100 to 790 μm, from 150 to 690 μm, or from 250 to 590 μm. It should be noted that, despite the use of the term diameter, the cross-section of the microcapillaries need not be round. Rather, they may take a variety of shapes, such as oblong as shown in FIGS. 4B and 4C. In such instances, the “diameter” shall be defined as the longest dimension of the cross-section of the microcapillary. This dimension is illustrated as λ in FIG. 4B. The “average” diameter shall be determined by taking three random cross-sections from a polymeric coating, measuring the diameter of each microcapillary therein, and determining the average of those measurements. The diameter measurement is conducted by cutting a cross section of the extruded article and observing under an optical microscope fitted with a scale to measure the size of the micro-capillary.

In one or more embodiments, the ratio of the thickness of the polymeric coating to the average diameter of the microcapillaries can be in the range of from 2:1 to 400:1

The spacing of the microcapillaries can vary depending on the desired properties to be achieved. Additionally, the spacing of the microcapillaries can be defined relative to the diameter of the microcapillaries. For instance, in various embodiments, the microcapillaries can be spaced apart a distance of less than 1 times the average diameter of the microcapillaries, and can be as high as 10 times the average diameter of the microcapillaries. In various embodiments, the microcapillaries can be spaced apart an average of 100 to 5,000 μm, an average of 200 to 1,000 μm, or an average of 100 to 500 μm. The measurement “spaced apart” shall be determined on an edge-to-edge basis, as illustrated by “s” in FIG. 2C.

### Test Methods

### Density

Density is determined according to ASTM D 792.

### Melt Index

Melt index, or I₂, is measured in accordance with ASTM D 1238, condition 190° C./2.16 kg, and is reported in grams eluted per 10 minutes.

### Tensile Strength and Elongation at Break

Measure tensile strength and elongation according to ASTM method D 638.

### Young's Modulus

Measure Young's Modulus also according to ASTM method D 638.

### Dynamic Mechanical Analysis

G′, the storage modulus, is measured by dynamic mechanical analysis (“DMA”) according to the following procedure: A TA Instrument DMA Q800 is used in bending mode, the sample is a rectangular specimen 17.5 mm long, 13 mm wide, and 1.25 mm thick. Testing conditions are as follows: 0.025% strain, temperature range of −60° C. to 80° C. ramping at 5° C./min, 1 Hz frequency, and 3 minutes soaking time.

### Materials

The following materials are employed in the Examples, below.

AXELERON™ FO 6548 BK (“MDPE”) is a medium-density polyethylene having a density of 0.946 g/cm³, a melt index (I₂) 0.82 g/10 min., and containing carbon black in an amount ranging from 2.35 to 2.85 wt % (ASTM D1603). AXELERON™ FO 6548 BK is commercially available from The Dow Chemical Company, Midland, Mich., USA.

ENGAGE™ 8200 is a polyolefin elastomer, specifically an ethylene/octene copolymer having a melt index (I₂) of 5.0 g/10 min., a density of 0.870 g/cm³, and a Mooney viscosity (ML 1+4 at 121° C.) of 8 according to ASTM D 1646. ENGAGE™ 8200 is commercially available from The Dow Chemical Company, Midland, Mich., USA.

IRGANOX™ 1010 is an antioxidant having the chemical name pentaerythritol tetrakis (3-(3,5-di-tert-butyl-4-hydroxyphenyl)propionate) and is commercially available from BASF SE, Ludwigshafen, Germany.

### Examples

### Sample Preparation

### Microcapillary Sample

Prepare one Sample (51) and one Comparative Sample (CS1) using a tape-extrusion system consisting of two single-screw extruders (1.9-cm and 3.81-cm Killion extruders) fitted with a microcapillary die capable of handling two polymer melt streams. This line consists of a 3.81-cm Killion single-screw extruder to supply polymer melt for the matrix material and a 1.9-cm Killion single-screw extruder to supply polymer melt for the microcapillaries via a transfer line to the microcapillary die. The die to be used in these Examples is described in detail in PCT Published Patent Application No. WO 2014/003761, specifically with respect to FIGS. 4A and 4A1, and the corresponding text of the written description, which is incorporated herein by reference. The die has 42 microcapillary nozzles, a width of 5 cm, and a die gap of 1.5 mm. Each microcapillary nozzle has an outer diameter of 0.38 mm and an inner diameter of 0.19 mm.

Sample S1 and comparative sample CS1 are prepared as follows. First, the extruders, gear pump, transfer lines, and die are heated to the operating temperatures with a “soak” time of about 30 minutes. The temperature profiles for the 3.81-cm and 1.9-cm Killion single-screw extruders are given in Table 1, below. Microcapillary polymer resins are charged into the hopper of the 1.9-cm Killion single-screw extruder, and the screw speed is turned up to the target value (30 rpm). As the polymer melt exits the microcapillary nozzles, the matrix polymer resins are filled into the hopper of 3.81-cm Killion single-screw extruder and the main extruder is turned on. The extruder screw of the 3.81-cm Killion single-screw extruder feeds the melt to a gear pump, which maintains a substantially constant flow of melt towards the microcapillary die. Then, the polymer melt from the 3.81-cm Killion single-screw extruder is divided into two streams, which meet with polymer strands from microcapillary nozzles. Upon exiting the extrusion die, the extrudate is cooled on a chill roll on a rollstack. Once the extrudate is quenched, it is taken by a nip roll. The line speed is controlled by a nip roll in the rollstack.

TABLE 1
Temperature Profiles of the 3.81-cm and 1.9-cm Killion Single-Screw Extruders

| | Extruders | | | | | | | | |
|---|---|---|---|---|---|---|---|---|---|
| | Extruder | Extruder | Extruder | Extruder | Adaptor | Transfer | Screen | Feed | Die |
| | Zone 1 | Zone 2 | Zone 3 | Zone 4 | Zone | Line | Changer | block | Zone |
| | (° F.) | (° F.) | (° F.) | (° F.) | (° F.) | (° F.) | (° F.) | (° F.) | (° F.) |
| 3.81-cm | 374 | 392 | 410 | 428 | 428 | 428 | 428 | 428 | 428 |
| Killion | | | | | | | | | |
| Extruder | | | | | | | | | |
| 1.9-cm | 338 | 410 | 428 | — | — | 428 | — | — | — |
| Killion | | | | | | | | | |
| Extruder | | | | | | | | | |

The extrusion system is set up to supply two polymer melt streams: a first polymer (3.81-cm Killion extruder) to make a continuous matrix surrounding a second polymer (1.9-cm Killion extruder) shaped as microcapillaries embedded in the first polymer. The first polymer (matrix) of S1 is MDPE, and the second polymer (microcapillary) of 51 is ENGAGE™ 8200. For CS1, both the first and second polymers are MDPE. The processing conditions and microcapillary dimension for 51 and CS1 are given in Table 2, below.

Estimated from density measurements, 51 contains 18 weight percent of the microcapillary material (ENGAGE™ 8200).

TABLE 2
Processing Conditions and Microcapillary Dimensions for S1 and CS1

| | CS1 | S1 |
|---|---|---|
| Matrix Material | MDPE | MDPE |
| Microcapillary Material | MDPE | ENGAGE ™ 8200 |
| Screw Speed of 3.81-cm | 15 | 15 |
| Extruder (rpm) | | |
| Screw Speed of 1.9-cm | 30 | 30 |
| Extruder (rpm) | | |
| Line Speed (ft/min) | 5 | 5 |
| Average Film Thickness | 1.05 | 1.31 |
| (mm) | | |
| Average Film Width (cm) | 4.5 | 4.2 |
| Area Percentage of | — | 17.4 |
| Microcapillaries in the Film | | |
| (%) | | |
| Long Axis of a | — | 243.2 |
| Microcapillary (μm) | | |
| Short Axis of a | — | 150.5 |
| Microcapillary (μm) | | |
| Space between Two | — | 152.2 |
| Microcapillaries (μm) | | |
| Film Surface to Inner | — | 120.1 |
| Surface of Microcapillary | | |
| (μm) | | |

### Melt Blend Sample

Prepare a second comparative sample (CS2) by melt blending MDPE with ENGAGE™ 8200. The ENGAGE™ 8200 constitutes 18 wt % of the melt blend. Melt blending of the polymers is accomplished as follows: The compound batches are prepared using a Brabender model Prep Mixer/Measuring Head laboratory electric batch mixer equipped with Roller Blades. The Prep-Mixer® is C. W. Brabender's largest Mixer/Measuring Head, which is a 3-piece design consisting of two heating zones and having a capacity of 350/420 ml depending on mixer blade configuration. The formulation consists of an MDPE base resin, ENGAGE™ 8200, and IRGANOX™ 1010 as an antioxidant. The MDPE resin is first loaded into the mixing bowl with the roller blades, which are rotating at 15 rpm. The process temperature set point for both zones is 180° C. After the base resin begins to melt, the ENGAGE™ 8200 and antioxidant additive are added and mixed at 40 rpm for an additional 5 minutes. The molten material is then removed from the mixer.

Plaque Preparation for property testing: the compounded material is first pre-weighed to the desired amount for plaque thickness and placed in between two Mylar sheets, then placed in between two aluminum sheets and stainless steel mold plates. The Mylar is in contact with the compounded material to prevent sticking to the metal plates. The filled mold is then placed into the press at 180° C. (+5° C. or −5° C.). The press is closed and pressed at 500 psi for 5 minutes. The pressure is increased up to 2500 psi for 5 minutes. The cooling system is set to cool the molded plaques at the rate of 10° C. per minute. The plaque is taken out when the temperature reaches 35° C.

### Example

Analyze each of CS 1, CS2, and S1 according to the Test Methods provided above. The results are provided in Table 1, below.

TABLE
Properties of Control 1, CS1, and S1

| | CS1 | CS2 | S1 |
|---|---|---|---|
| Density (g/cm³) | 0.946 | 0.932 | 0.930 |
| Tensile Strength (“TS”) (psi) | 4,311 | 4,259 | 3,388 |
| Elongation at Break (“EB”) | 870 | 915 | 857 |
| (%) | | | |
| Young's Modulus (psi) | 50,428 | 24,358 | 13,541 |
| DMA G′ @ 25° C. (MPa) | 1,271 | 885 | 552 |
| DMA G′ @ −25° C. (MPa) | 2,577 | 1,982 | 1,290 |
| DMA G′ @ −50° C. (MPa) | 2,947 | 2,595 | 1,544 |

As can be seen from the results provided in Table 1, S1 exhibits good mechanical properties, but with significantly reduced modulus compared to CS1. Compared to the melt blend of CS2, and based on both Young's modulus and DMA data, S1 exhibits much lower modulus values at both room temperature as well as low temperatures. Furthermore, with the elastomer phase fully encapsulated, S1 will retain the desirable surface properties of the MDPE material.

1. A coated conductor, comprising:
(a) a conductor; and
(b) an elongated polymeric coating surrounding at least a portion of said conductor,
wherein said elongated polymeric coating comprises a polymeric matrix material and a plurality of microcapillaries which extend substantially in the direction of elongation of said elongated polymeric coating,
wherein at least a portion of said microcapillaries contain a polymeric microcapillary material,
wherein said polymeric microcapillary material is an elastomer.

2. The coated conductor of claim 1, wherein said polymeric matrix material completely surrounds each of said microcapillaries when viewed from a cross-section taken orthogonal to the direction of elongation of said elongated polymeric coating.

3. The coated conductor of claim 1, wherein said polymeric microcapillary material has a lower flexural modulus than said polymeric matrix material.

4. The coated conductor of claim 1, wherein said polymeric matrix material is a thermoplastic polymer, a crosslinkable polymer, or a crosslinked polymer.

5. The coated conductor of claim 4, wherein said polymeric matrix material is selected from the group consisting of an ethylene-based polymer, a polyamide, a polyester, a polycarbonate, and combinations of two or more thereof.

6. The coated conductor of claim 1, wherein said polymeric microcapillary material is selected from the group consisting of an olefin elastomer, a silicone elastomer, a urethane elastomer, an amorphous rubber, and combinations of two or more thereof.

7. The coated conductor of claim 1, wherein said polymeric matrix material comprises medium-density polyethylene, wherein said polymeric microcapillary material comprises an ethylene/octene copolymer olefin elastomer.

8. The coated conductor of claim 1, wherein said microcapillaries have an average diameter in the range of from 0.5 μm to 2,000 μm, wherein said microcapillaries have a cross-sectional shape selected from the group consisting of circular, rectangular, oval, star, diamond, triangular, square, curvilinear, and combinations thereof, wherein said elongated polymeric coating has a thickness in the range of from 15 to 120 mils, wherein said coated conductor optionally comprises one or more additional coatings, wherein said elongated polymeric coating is the outermost coating of said coated conductor.

9. The coated conductor of claim 1, wherein said polymeric matrix material is present in the form of a single-layer construction.

10. The coated conductor of claim 1, wherein the ratio of the thickness of said polymeric protective component to the average diameter of said microcapillaries is in the range of from 2:1 to 400:1.
